(19) United States
(12) Patent Application Publication
(10) Pub. No.: US 2026/0269980 A1
(43) Pub. Date: Sep. 10, 2026

(54) ONBOARD DEVICE, PROGRAM, AND INFORMATION PROCESSING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Naoki ADACHI, Yokkaichi-shi, Mie (JP); Kenya WADA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/166,340

(22) PCT Filed: Feb. 29, 2024
(86) PCT No.: PCT/JP2024/007514

§ 371 Date: Sep. 17, 2025

(30) Foreign Application Priority Data
Mar. 20, 2023 (JP) 2023-044681

(51) Int. Cl. H04L 1/00; H04L 67/12

(52) U.S. Cl. CPC H04L 1/0061; H04L 67/12

(57) ABSTRACT

An onboard device includes a processing unit which receives cyclic data transmitted cyclically over an in-vehicle network, and determines, in a case where a plurality of event data of the same class as the cyclic data are received between reception times of two pieces of consecutively received cyclic data, whether the interval of the reception times of the consecutively received event data is longer than an event data transmission prohibition period, and determining, in a case where the interval of the reception times of the two pieces of consecutively received event data is not longer than the prohibition period, that at least one of the two pieces of consecutively received event data is anomalous, and performing, in a case where the interval of the reception times is longer than the event data transmission prohibition period, validity determination relating to the value of the payload of the event data.

### CROSS-REFERENCE TO RELATED APPLICATIONS

This application is the U.S. national stage of PCT/JP2024/007514 filed on Feb. 29, 2024, which claims priority of Japanese Patent Application No. JP 2023-044681 filed on Mar. 20, 2023, the contents of which are incorporated herein.

### TECHNICAL FIELD

The present disclosure relates to an onboard device, a program and an information processing method.

### BACKGROUND

Conventionally, the CAN communication protocol has been widely employed in communication between multiple onboard ECUs (Electronic Control Units) installed in a vehicle. The number of onboard ECUs that are installed tends to increase as vehicles become more multifunctional and sophisticated, and the onboard ECUs are divided into groups (segments) to constitute a vehicle network, with onboard ECUs in the same group being connected by a common communication line and performing transmission and reception of data with each other via this communication line, and transmission and reception of data between the onboard ECUs of different groups being relayed by an onboard relay device (gateway) (e.g., JP 2013-131907A).

In addition to the onboard relay device (gateway), the vehicle network of JP 2013-131907A includes a vehicle network monitoring device that is connected to each segment of the vehicle network and detects unauthorized data (messages) flowing through the vehicle network. When unauthorized data (messages) are detected, the vehicle network monitoring device transmits alert information (message code) to an onboard control device (onboard ECU).

There is a problem with the vehicle network monitoring device of JP 2013-131907A in that consideration is not given to efficiently detecting anomalous (unauthorized) messages, based on association with the transmission cycle or the like, in a communication mode in which data is transmitted cyclically.

An object of the present disclosure is to provide an onboard device and the like that are able to detect anomalous data efficiently in a communication mode in which data is transmitted cyclically.

### SUMMARY

An onboard device according to one mode of the present disclosure is an onboard device to be connected to an in-vehicle network installed in a vehicle, including a processing unit configured to perform processing relating to validity determination of data flowing through the in-vehicle network, the processing unit receiving cyclic data transmitted cyclically over the in-vehicle network, determining, in a case where a plurality of event data of the same class as the cyclic data are received between reception times of two pieces of consecutively received cyclic data, whether an interval of the reception times of two pieces of consecutively received event data is longer than an event data transmission prohibition period determined as a period in which transmission of the event data is prohibited, determining, in a case where the interval of the reception times of the two pieces of consecutively received event data is not longer than the event data transmission prohibition period, that at least one of the two pieces of consecutively received event data is anomalous, and performing, in a case where the interval of the reception times of the two pieces of consecutively received event data is longer than the event data transmission prohibition period, validity determination relating to a value of a payload of the event data.

### Advantageous Effects of Disclosure

According to one mode of the present disclosure, an onboard device and the like can be provided that detect anomalous data efficiently in a communication mode in which data is transmitted cyclically.

### BRIEF DESCRIPTION OF DRAWINGS

FIG. 1 is a schematic diagram illustrating the configuration of an onboard system that includes an onboard device according to a first embodiment.

FIG. 2 is a block diagram illustrating the physical configuration of the onboard device.

FIG. 3 is an illustrative diagram relating to a data class table.

FIG. 4 is an illustrative diagram relating to a data reception list.

FIG. 5 is an illustrative diagram relating to validity determination of event data (event data transmission prohibition period).

FIG. 6 is an illustrative diagram relating to an event data transmission prohibition period (fixed) of event data.

FIG. 7 is an illustrative diagram relating to an event data transmission prohibition period (variable) of event data.

FIG. 8 is an illustrative diagram relating to validity determination of event data (backcast: pattern 1).

FIG. 9 is an illustrative diagram relating to validity determination of event data (payload change: pattern 1).

FIG. 10 is an illustrative diagram relating to validity determination of event data (backcast: pattern 2).

FIG. 11 is an illustrative diagram relating to validity determination of event data (payload change: pattern 2).

FIG. 12 is an illustrative diagram (matrix table) relating to a determination mode (determination table) for event data used by a processing unit of the onboard device.

FIG. 13 is a flowchart (main processing) illustrating processing by the processing unit of the onboard device.

FIG. 14 is a flowchart (backcast processing) illustrating processing by the processing unit of the onboard device.

FIG. 15 is an illustrative diagram relating to validity determination (payload value) of a plurality of cyclic data according to a second embodiment (plural reception in normal cycle range).

FIG. 16 is an illustrative diagram relating to validity determination of a plurality of cyclic data (event data transmission prohibition period).

FIG. 17 is a flowchart illustrating processing by the processing unit of the onboard device.

### DETAILED DESCRIPTION OF PREFERRED EMBODIMENTS

Initially, modes of the present disclosure will be enumerated and described. Also, at least some of the embodiments described below may be freely combined.

(1) An onboard device according to one mode of the present disclosure is an onboard device to be connected to an in-vehicle network installed in a vehicle, including a processing unit configured to perform processing relating to validity determination of data flowing through the in-vehicle network, the processing unit receiving cyclic data transmitted cyclically over the in-vehicle network, determining, in a case where a plurality of event data of the same class as the cyclic data are received between reception times of two pieces of consecutively received cyclic data, whether an interval of the reception times of two pieces of consecutively received event data is longer than an event data transmission prohibition period determined as a period in which transmission of the event data is prohibited, determining, in a case where the interval of the reception times of the two pieces of consecutively received event data is not longer than the event data transmission prohibition period, that at least one of the two pieces of consecutively received event data is anomalous, and performing, in a case where the interval of the reception times of the two pieces of consecutively received event data is longer than the event data transmission prohibition period, validity determination relating to a value of a payload of the event data.

With this mode, the processing unit of the onboard device receives (acquires) a plurality of data (frames) such as CAN messages or IP packets transmitted from onboard ECUs that are connected to an in-vehicle network. The data transmitted and received between the onboard ECUs via the in-vehicle network includes cyclic data (periodic messages) that are transmitted cyclically and event data (event messages) that are transmitted when a predetermined event occurs outside the cycle. Matters such as handling or processing content relating to the cyclic data may be similar to the processing relating to validity determination of data (corresponds to cyclic data) described in International Patent Publication No. WO 2022/185566(WO/2022/185566 ), for example. That is, in the present embodiment, by applying or invoking the matters described in International Patent Publication No. WO 2022/185566 as appropriate, the processing unit of the onboard device may, in relation to processing relating to cyclic data, be configured to perform similar processing to the processing relating to validity determination of data described in International Patent Publication No. WO 2022/185566. The data is classified into a plurality of classes (types) for each communication protocol. For example, when the communication protocol is TCP/IP, it may be determined whether data belongs to the same class or different classes, according to the sameness of the port numbers (TCP port numbers, UDP port numbers), source addresses, destination addresses, or a combination thereof included in the IP packets. When the communication protocol is CAN (Controller Area Network) or CAN/FD, it may be determined whether data belongs to the same class or different classes, according to the sameness of the CAN message IDs (CAN-IDs). That is, a plurality of data (CAN messages) with the same message ID (CAN-ID) correspond to data belonging to the same class (same class of data). When two pieces of cyclic data belonging to the same class are received consecutively, the processing unit of the onboard device determines whether a plurality of event data (event messages) of the same class as the cyclic data have been received between the reception times of the two pieces of consecutively received cyclic data. If it is determined that a plurality of event data, being two or more pieces, was received, the processing unit of the onboard device determines the validity of two pieces of consecutively received event data, out of the plurality of event data, based on comparison between the reception time interval of the two pieces of consecutively received event data and the length of the event data transmission prohibition period. The event data transmission prohibition period is the period from when one piece of event data is transmitted until when an event data transmission prohibition time period in which transmission of the next piece of event data is prohibited elapses, based on the transmission time of the one piece of event data. If the reception time interval of the two pieces of consecutively received event data is longer (larger) than the event data transmission prohibition period, the processing unit of the onboard device provisionally determines that these two pieces of event data are normal from detection of the transmission timing of event data, and performs further determination processing, based on the value of the payload (payload value) of the event data. When the reception time interval of two pieces of consecutively received event data is not longer than the event data transmission prohibition period, that is, when the reception time interval is less than or equal to the event data transmission prohibition period, the processing unit of the onboard device determines that at least one of the two pieces of event data is anomalous. In this case, the processing unit of the onboard device may be configured to determine that the two pieces of event data are both anomaly detected (range) “anomalous (range)”. The reception time interval of two pieces of consecutively received event data being less than or equal to the event data transmission prohibition period means that the reception time of the piece of event data received second, out of the two pieces of consecutively received event data, is included in the range of the event data transmission prohibition period set on the basis of the reception time of the event data received first. In an onboard system that controls the transmission timing of event data using the event data transmission prohibition period, it is assumed that, when the reception time of event data is within the event data transmission prohibition period, unauthorized (anomalous) data arising from an attack, for example, was transmitted. As such, even if a plurality of event data of the same class as the cyclic data are received between the reception times of two pieces of consecutively received cyclic data, primary determination relating to the validity of the event data can be efficiently performed from detection of the transmission timing of event data, by contrasting the reception time interval of these pieces of event data with the event data transmission prohibition period. In the present embodiment, determining the validity of data with the processing unit of the onboard device means executing determination processing as to whether the data (event data, cyclic data) is normal or anomalous. In addition, as a result of the determination processing, the processing unit of the onboard device determines that the data is anomalous or normal, and stores or outputs the determination result (anomalous determination or normal determination) to a storage unit.

(2) In the onboard device according to one mode of the present disclosure, the event data transmission prohibition period set for each of the plurality of event data of the same class received between the reception times of two pieces of consecutively received cyclic data may be the same period.

With this mode, when a plurality of event data are received between the reception times of two pieces of consecutively received cyclic data, the processing unit performs determination processing, without changing the event data transmission prohibition period set on the basis of the reception times of the event data, that is, with the event data transmission prohibition time period indicating the length of the event data transmission prohibition period set to the same value. By using the same value determined in advance according to the type of data (data class) including cyclic data and event data, without dynamically changing the event data transmission prohibition period (event data transmission prohibition time period), in this way, the logic design relating to the determination processing can be simplified, and an increase in processing load on the processing unit can be suppressed.

(3) In the onboard device according to one mode of the present disclosure, the processing unit may set a normal cycle range on a basis of the reception time of the cyclic data received first, out of the two pieces of consecutively received cyclic data, and may, in a case where the event data transmission prohibition period set on a basis of the reception time of any of the plurality of received event data overlaps with the normal cycle range, shorten the event data transmission prohibition period such that an end time of the event data transmission prohibition period is before a start time of the normal cycle range.

With this mode, when the processing unit receives a plurality of event data between the reception times of two pieces of consecutively received cyclic data, the event data transmission prohibition period set on the basis of the reception times of the event data is shortened, according to whether there is overlap with the normal cycle range set on the basis of the reception time of the cyclic data received first. When a plurality of event data are received between the reception times of two pieces of consecutively received cyclic data, the reception times of the event data are arranged in time series. At this time, the interval between the reception time of the event data received last and the reception time of the cyclic data received second, out of the two pieces of consecutively received cyclic data, will be shorter than the interval between the reception time of the event data initially received and the reception time of the cyclic data received second. Accordingly, it is envisaged that cases will arise where, even if the event data transmission prohibition period set on the basis of the reception time of the event data initially received does not overlap with the normal cycle range, the event data transmission prohibition period set on the basis of the reception time of the event data received last overlaps with the normal cycle range. It is envisaged that, when the event data transmission prohibition period set on the basis of one of the event data overlaps with the normal cycle range set on the basis of the reception time of the cyclic data received first in this way, the processing mode on data (cyclic data or event data) received during the period that overlaps (overlapping period) will be complicated. As such, when the event data transmission prohibition period overlaps with the normal cycle range, the processing unit shortens the event data transmission prohibition period, such that the end time of the event data transmission prohibition period is before the start time of the normal cycle range, and thus reliably prevents the overlapping period from arising. It is thereby possible to prevent processing relating to the second piece of cyclic data received in the normal cycle range from being affected by the reception of event data, and to efficiently perform processing relating to this second piece of cyclic data.

(4) In the onboard device according to one mode of the present disclosure, the processing unit may, in a case where a difference between a value of a payload of the cyclic data received second, out of the two pieces of consecutively received cyclic data, and a value of a payload of the event data received directly before the cyclic data received second is less than or equal to a predetermined value, determine that the event data received directly before is normal, and may, based on the value of the payload of the event data determined to be normal and a value of a payload of other event data received before the event data determined to be normal, perform validity determination of the other event data.

With this mode, event data has a transmission characteristic of being transmitted before cyclic data that is transmitted in the next transmission cycle, when a phenomenon (event) occurs such as a change in the payload value of cyclic data transmitted directly therebefore. In this case, it is assumed, in terms of the product specification, that the payload value (signal values) of cyclic data received directly after the reception time of event data (cyclic data received second, out of two pieces of consecutively received cyclic data) will be substantively the same as the payload value (signal values) of the event data. In determining the substantive sameness of payload values, using a predetermined value (threshold value for difference determination) that is used when determining the difference in payload value, the processing unit of the onboard device may be configured to set the predetermined value (threshold value for difference determination) to 0 or a comparatively small value close to 0. The processing unit of the onboard device thereby determines that the event data is normal, when the difference between the payload values (signal values) is not more than 0, that is, when the payload values are the same (perfectly matched). The processing unit of the onboard device determines that the event data is anomalous, when the difference between the payload values (signal values) exceeds 0, that is, when the payload values are different. By performing such processing, determination validity of the event data can be efficiently performed, according to a transmission characteristic of event data, namely, that event data is transmitted outside the transmission cycle when a predetermined phenomenon (event) occurs. Furthermore, the processing unit of the onboard device similarly performs processing similar to the comparative processing (backcast processing) with the payload value of the cyclic data received second on two pieces of consecutively received event data. That is, the processing unit of the onboard device performs comparative processing (backcast processing) on not only the event data received directly before the cyclic data received second, but also on the event data received before the event data received directly before the cyclic data received second. The processing unit of the onboard device may be configured to perform comparative processing (backcast processing) on all of the event data, by retrospectively performing comparative processing (backcast processing) sequentially on two pieces of consecutive event data with the payload value of event data determined to be normal in this way. Alternatively, the processing unit of the onboard device may be configured to retrospectively perform comparative processing (backcast processing) sequentially on two pieces of event data having consecutive reception times, out of a plurality (three or more pieces) of event data whose reception times are arranged in time series, and to suspend the comparative processing (backcast processing) if any of the event data is determined to be anomalous. In this way, by retrospectively performing comparative processing (backcast processing), which is based on the payload value of the cyclic data received second, sequentially on a plurality of event data, validity determination of the event data can be efficiently performed, according to a transmission characteristic of event data, namely, that event data is transmitted outside the transmission cycle when a predetermined phenomenon (event) occurs. Furthermore, the processing unit of the onboard device may be configured to perform comparative processing (backcast processing) with the payload value of the cyclic data received second together with comparative processing (forecast processing) with the payload value of the cyclic data received first. At this time, the processing unit of the onboard device may be configured to perform parallel computation (parallel processing) of the backcast processing and the forecast processing, using multi-core or multi-CPU hardware resources. By parallelizing a plurality of types of processing on event data in this way, the processing time (elapsed time) required for validity determination processing of event data can be reduced.

(5) In the onboard device according to one mode of the present disclosure, the processing unit may perform validity determination on the plurality of event data, based on a change in the value of the payload between the plurality of event data, and may, in a case where there is no change in the value of the payload between two pieces of consecutively received event data, determine that at least one of the two pieces of consecutively received event data is anomalous.

With this mode, when event data of the same class as the cyclic data is transmitted between the reception times of two pieces of consecutively received cyclic data, the processing unit of the onboard device receives all of the transmitted event data, and stores the received event data in a storage unit of the onboard device in association with the respective reception times thereof. At this time, the two pieces of consecutively received cyclic data may also be stored in the storage unit in association with the respective reception times thereof. At this time, when the processing unit of the onboard device receives a plurality of event data between the reception times of the two pieces of consecutively received cyclic data, the plurality of event data are arranged in time series according to reception time. The processing unit of the onboard device performs validity determination on the plurality of event data arranged in time series according to reception time, based on the change in the value of the payload between the plurality of event data. The processing unit of the onboard device determines that the event data is normal if there is a change in the value of the payload between the plurality of event data, and determines that the event data is anomalous if there is no change in the value of the payload. The processing unit of the onboard device performs validity determination on two pieces of event data that are adjacent at reception time, according to whether there is a change in the value of the payload between the two pieces of event data or according to the extent of the change (degree of change). Validity determination of the event data can thereby be efficiently performed, according to a transmission characteristic of event data, namely, that event data is transmitted outside the transmission cycle when a predetermined phenomenon (event) occurs.

(6) In the onboard device according to one mode of the present disclosure, the processing unit may, in a case where it is determined that at least one of the two pieces of consecutively received event data is anomalous, suspend determination processing that is based on comparison with the value of the payload of the event data determined to be normal or the cyclic data received second, with respect to other event data received before the event data determined to be anomalous.

With this mode, the processing unit of the onboard device retrospectively performs comparative processing (backcast processing), which is based on the payload value of the cyclic data received second, sequentially on a plurality of event data. In this case, the validity of the event data received directly before the cyclic data received second is determined, based on comparison with the payload value of the cyclic data received second (based on whether the values are substantively the same). If it is determined that the event data received directly before is normal, the validity of the event data received directly before the event data determined to be normal is determined, based on comparison with the payload value of the event data determined to be normal (based on whether the values differ). If, out of two pieces of event data having consecutive reception times in this way, the payload value of the event data received second and determined to be normal is different from the payload value of the event data received first (values not substantively the same), the processing unit of the onboard device determines that the event data received first is normal. If, out of two pieces of event data having consecutive reception times in this way, the payload value of the event data received second and determined to be normal is not different from the payload value of the event data received first (values substantively the same, no change), the processing unit of the onboard device determines that the event data received first is anomalous. If it is determined that event data is anomalous, the processing unit of the onboard device suspends the backcast processing, without performing determination processing on the event data received before the event data determined to be anomalous. In performing validity determination by backcast processing sequentially from event data close to the reception time of the cyclic data received second, out of a plurality of event data arranged in time series in this way, the processing unit of the onboard device suspends the backcast processing if any of the event data is determined to be anomalous. Backcast processing on other event data received before the event data determined to be anomalous, that is, other event data whose reception time is closer to the reception time of the first cyclic data than is the reception time of the event data determined to be anomalous, can thereby be dispensed with, and the processing load on the processing unit can be reduced.

(7) In the onboard device according to one mode of the present disclosure, the processing unit may, in a case where it is determined that at least one of the two pieces of consecutively received event data is anomalous, continue determination processing that is based on comparison with the value of the payload of the event data determined to be normal or the cyclic data received second, with respect to other event data received before the event data determined to be anomalous.

With this mode, the processing unit of the onboard device performs validity processing on all of the event data, by retrospectively performing comparative processing (backcast processing) on the basis of the payload value of the cyclic data received second, sequentially on the plurality of event data. In this case, if any of the event data is determined to be anomalous, validity determination of the event data received directly before the event data determined to be anomalous is performed with the event data used in the validity determination of the event data determined to be anomalous or the cyclic data received second. The event data used in the validity determination of the event data determined to be anomalous is event data whose reception time is closest to the reception time of the event data determined to be anomalous and that has already been determined to be normal by backcast processing. If there is no event data whose reception time is closest to the reception time of the event data determined to be anomalous and that has already been determined to be normal by backcast processing, this means that the validity determination of the event data determined to be anomalous was performed with the cyclic data received second. It is envisaged that there will be cases where, as a result of retrospectively performing backcast processing on a plurality of event data whose reception times are arranged in time series in this way, one of the event data is determined to be anomalous. As such, determination of the validity of all of the event data can be efficiently performed, through comparison with the payload value of data (event data or cyclic data received second) whose reception time is closest to the reception time of the event data determined to be anomalous and that has already been determined to be normal.

(8) In the onboard device according to one mode of the present disclosure, the processing unit may, in a case where a plurality of cyclic data are received in a normal cycle range set on a basis of the reception time of the cyclic data received first and whose upper limit value and lower limit value are set with a transmission cycle determined based on the class of the cyclic data as a reference value, determine whether the value of the payload of each of the plurality of cyclic data is within a normal value range determined in advance according to the class of the cyclic data, and may, in a case where it is determined that the value of the payload of the cyclic data is not within the normal value range, determine that the cyclic data is anomalous.

With this mode, the normal value range of the payload value (signal values) included in event data and cyclic data, that is, the range of values that the payload value (signal values) can take, is determined in advance, according to the data class of the event data and cyclic data which is determined by message ID or port number, for example. The normal value range that depends on the class of the data may, for example, be stored in the storage unit in table format (data class table). The processing unit of the onboard device determines whether the payload value (signal values) of each of the plurality of cyclic data received within the same normal cycle range is within the normal value range, with reference to the data class table, for example. If it is determined that the payload value is not within the normal value range, the processing unit of the onboard device determines that the cyclic data is anomalous. In this case, the processing unit of the onboard device may be configured to determine that the cyclic data corresponds to specific anomaly detected “anomaly detected (specific)”. That is, it is assumed that cyclic data whose payload value (signal values) is outside the normal value range is highly likely to be unauthorized (anomalous) data arising from an attack, for example, thus enabling unauthorized (anomalous) data to be efficiently detected. The processing unit of the onboard device may, in the case where a plurality of cyclic data are received within the same normal cycle range, be configured to transition to a reference data reception state (reference message acquisition state) in which data (cyclic data) that serves as a reference in specifying the next normal cycle range is received, as described in International Patent Publication No. WO 2022/185566 (WO/2022/185566), for example. Alternatively, in the case where a plurality of cyclic data are received within the same normal cycle range but there is only one piece of cyclic data whose payload value (signal values) is within the normal value range and that is determined to be normal, among of the plurality of cyclic data, the processing unit of the onboard device may be configured to specify the next normal cycle range on the basis of the reception time of the one piece of cyclic data determined to be normal. In this case, the processing unit of the onboard device maintains the determination execution state (cycle detection execution state) in which the validity of received data (cyclic data) is determined based on the specified normal cycle range.

(9) In the onboard device according to one mode of the present disclosure, the processing unit may, in a case where it is determined that the values of the payloads of the cyclic data are within the normal value range, determine whether the interval of the reception times of two pieces of consecutively received cyclic data, out of the plurality of cyclic data received in the normal cycle range, is longer than the event data transmission prohibition period, may, in a case where the interval of the reception times of the two pieces of consecutively received cyclic data is not longer than the event data transmission prohibition period, determine that at least one of the two pieces of consecutively received cyclic data is anomalous, and may, in a case where the interval of the reception times of the two pieces of consecutively received cyclic data is longer than the event data transmission prohibition period, determine that the two pieces of consecutively received cyclic data are normal.

With this mode, the processing unit of the onboard device determines whether the payload value (signal values) of each of the plurality of received cyclic data is within the normal value range, with reference to the data class table, for example. If it is determined that the plurality of received cyclic data are within the normal value range, the processing unit of the onboard device determines whether the interval of the reception times of the two pieces of consecutively received cyclic data that are determined to be within the normal value range is longer than the event data transmission prohibition period (event data transmission prohibition time period). That is, the processing unit determines, with respect to two pieces of cyclic data received consecutively within the same normal cycle range, whether the reception time of the later cyclic data is included in the event data transmission prohibition period set on the basis of the reception time of the earlier cyclic data. If the interval of the reception times of the two pieces of cyclic data received consecutively within the same normal value range is not longer than the event data transmission prohibition period (event data transmission prohibition time period), that is, the interval of the reception times of the two pieces of cyclic data is shorter than the event data transmission prohibition period (event data transmission prohibition time period), the processing unit of the onboard device determines that at least one of the two pieces of cyclic data is anomalous. At this time, the reception time of the later cyclic data will be included in the event data transmission prohibition period set on the basis of the reception time of the earlier cyclic data, out of the two pieces of cyclic data received consecutively within the same normal cycle range. In this case, the processing unit of the onboard device may be configured to determine that the two pieces of cyclic data received consecutively within the same normal value range are both anomaly detected (range) “anomalous (range)”. If it is determined that the interval of the reception times of the two pieces of cyclic data received consecutively within the same normal value range is longer than the event data transmission prohibition period (event data transmission prohibition time period), the processing unit of the onboard device determines that the two pieces of cyclic data are both normal. That is, the payload values of these two pieces of cyclic data are within the normal value range and the interval of the reception times of the two pieces of cyclic data is longer than the event data transmission prohibition period (event data transmission prohibition time period), and thus, in terms of the payload value itself and data transmission characteristics, these two pieces of cyclic data can be said to be normal. Accordingly, even when the processing unit of the onboard device is configured to perform processing with data received within the normal cycle range regarded as cyclic data, for example, it is possible that, in the case where two pieces of cyclic data are received consecutively within the same normal value range, one of the two pieces of cyclic data is event data. That is, it is envisaged that, when the upper and lower limit values of the normal cycle range are set to comparatively large values, and the normal cycle range is set to be longer than the event data transmission prohibition period (event data transmission prohibition time period), cyclic data and substantively event data may be received in the same normal cycle range. Even in such cases, the processing unit of the onboard device is able to perform validity determination in terms of the payload value and data transmission characteristics of the two pieces of data (cyclic data and substantively event data) received consecutively within the same normal value range. The processing unit of the onboard device may, based on the result of comparing the payload values of two pieces of data (cyclic data and substantively event data) received consecutively within the same normal value range, be configured to differentiate cyclic data and event data, out of the two pieces of data. Event data has the transmission characteristic of being transmitted when a predetermined event occurs such as a change in the payload value. Accordingly, when the payload values of two pieces of data received consecutively within the same normal value range are the same value, the processing unit of the onboard device may be configured to differentiate that the data received first is substantively event data and the data received second is cyclic data. Furthermore, when the payload values of two pieces of data received consecutively within the same normal value range are different, the processing unit of the onboard device may be configured to differentiate that the data received first is cyclic data and the data received second is substantively event data. Even if it is determined that the two pieces of data (cyclic data and substantively event data) received consecutively within the same normal value range are both normal in this way, the processing unit of the onboard device may be configured to transition to the reference data reception state (reference message acquisition state) in which data (cyclic data) that serves as a reference in specifying the next normal cycle range is received, as described in International Patent Publication No. WO 2022/185566(WO/2022/185566 ), for example. Alternatively, even when a plurality (two pieces) of data (cyclic data and substantively event data) are received within the same normal cycle range, the processing unit of the onboard device may, in the case where it can be differentiated (specified) that one of the data is cyclic data, be configured to specify the next normal cycle range on the basis of the reception time of the cyclic data that was differentiated (specified). In this case, the processing unit of the onboard device maintains the determination execution state (cycle detection execution state) in which the validity of received data (cyclic data) is determined based on the specified normal cycle range.

(10) A program according to one mode of the present disclosure causes a computer connected to an in-vehicle network to execute processing for receiving cyclic data transmitted cyclically over the in-vehicle network, determining, in a case where a plurality of event data of the same class as the cyclic data are received between reception times of two pieces of consecutively received cyclic data, whether an interval of the reception times of two pieces of consecutively received event data is longer than an event data transmission prohibition period determined as a period in which transmission of the event data is prohibited, determining, in a case where the interval of the reception times of the two pieces of consecutively received event data is not longer than the event data transmission prohibition period, that at least one of the two pieces of consecutively received event data is anomalous, and performing, in a case where the interval of the reception times of the two pieces of consecutively received event data is longer than the event data transmission prohibition period, validity determination relating to a value of a payload of the event data.

With this mode, a program can be provided that causes a computer to operate as an onboard device that is able to detect anomalous data efficiently in a communication mode in which data is transmitted cyclically.

(11) An information processing method according to one mode of the present disclosure causes a computer connected to an in-vehicle network to execute processing for receiving cyclic data transmitted cyclically over the in-vehicle network, determining, in a case where a plurality of event data of the same class as the cyclic data are received between reception times of two pieces of consecutively received cyclic data, whether an interval of the reception times of two pieces of consecutively received event data is longer than an event data transmission prohibition period determined as a period in which transmission of the event data is prohibited, determining, in a case where the interval of the reception times of the two pieces of consecutively received event data is not longer than the event data transmission prohibition period, that at least one of the two pieces of consecutively received event data is anomalous, and performing, in a case where the interval of the reception times of the two pieces of consecutively received event data is longer than the event data transmission prohibition period, validity determination relating to a value of a payload of the event data.

With this mode, an information processing method can be provided that causes a computer to operate as an onboard device that is able to detect anomalous data efficiently in a communication mode in which data is transmitted cyclically.

The present disclosure will be specifically described based on drawings showing embodiments thereof. An onboard device 2 according to embodiments of the present disclosure will be described below with reference to the drawings. Note that the present disclosure is not limited to these illustrative examples and is defined by the patent claims, and all changes that come within the meaning and range of equivalency of the patent claims are intended to be embraced therein.

### First Embodiment

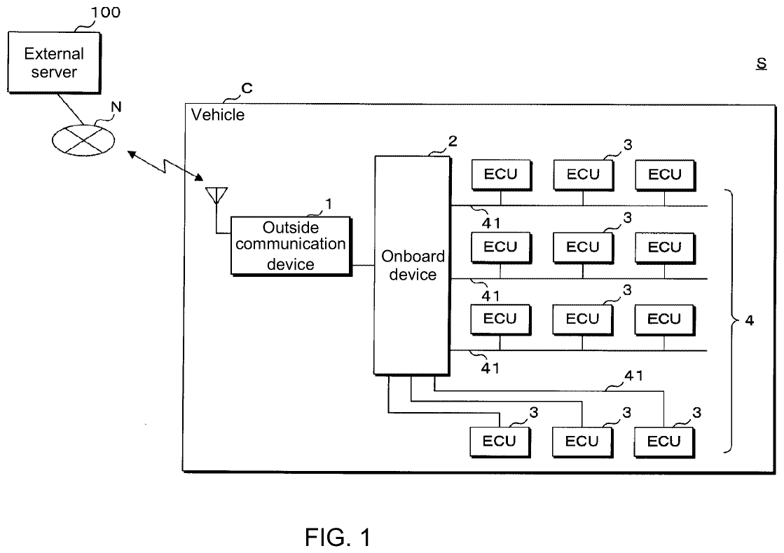

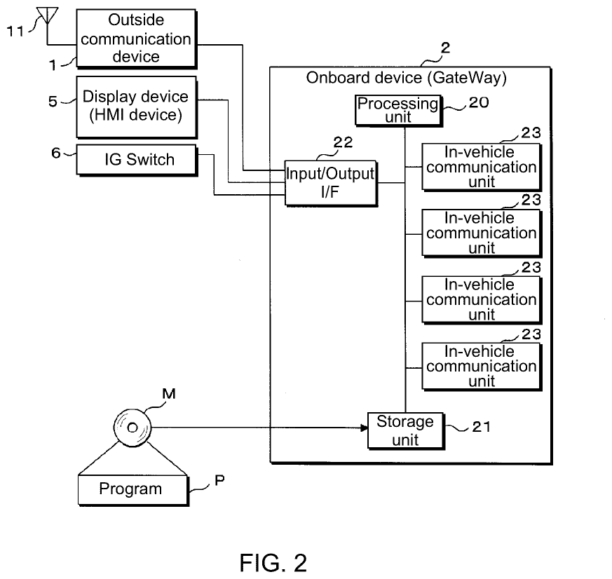

Hereinafter, an embodiment will be described based on the drawings. FIG. 1 is a schematic diagram illustrating the configuration of an onboard system S that includes the onboard device 2 according to a first embodiment. FIG. 2 is a block diagram illustrating the physical configuration of the onboard device 2.

The onboard system S is constituted with the onboard device 2 installed in a vehicle C as a main device, and the onboard device 2 is communicably connected to an outside communication device 1 and a plurality of onboard ECUs 3. The onboard device 2 relays communication between the plurality of onboard ECUs 3 that are installed in the vehicle C. The onboard device 2 may be configured to communicate via the outside communication device 1 with an external server 100 connected via an outside network N, and relay communication between the external server 100 and the onboard ECUs 3 installed in the vehicle C.

The external server 100 is a computer such as a server that is connected to the outside network N, which is the Internet or a public network, for example, and includes a storage unit 21 or storage device that is constituted by a RAM (Random Access Memory), a ROM (Read Only Memory), a hard disk, or the like. The storage unit 21 or the like of the external server 100 is included in a storage area accessible by the onboard device 2.

The vehicle C is equipped with the outside communication device 1, the onboard device 2, a display device 5, and the plurality of onboard ECUs 3 for controlling various onboard equipment. The onboard device 2 and the outside communication device 1 are communicably connected by a wiring harness such as a serial cable, for example. The onboard device 2 and the onboard ECUs 3 are communicably connected by communication lines 41 and an in-vehicle network 4 that support a communication protocol such as CAN (Control Area Network; registered trademark), CAN/FD or Ethernet (registered trademark). The onboard device 2 and the onboard ECUs 3 may also be configured to support a communication protocol such as LIN, MOST, or FlexRay.

The outside communication device 1 includes an outside communication unit (not shown) and an input/output I/F (not shown) for communicating with the onboard device 2. The outside communication unit is a communication device for performing wireless communication using a mobile communication protocol such as 3G, LTE, 4G, 5G or WiFi, and performing transmission and reception of data with the external server 100 via an antenna 11 connected to the outside communication unit. Communication between the outside communication device 1 and the external server 100 is performed via the outside network N, which is a public network or the Internet, for example. The input/output I/F is a communication interface for performing serial communication, for example, with the onboard device 2. The outside communication device 1 and the onboard device 2 communicate with each other via the input/output I/F and a wiring harness such as a serial cable connected to the input/output I/F. In the present embodiment, the outside communication device 1 is a separate device from the onboard device 2, and these devices are communicably connected by the input/output I/F and the like, but is not limited thereto. The outside communication device 1 may be built into the onboard device 2 as a constituent part of the onboard device 2.

The onboard device 2 includes a processing unit 20, the storage unit 21, an input/output I/F 22, and an in-vehicle communication unit 23. The onboard device 2 is an onboard relay device such as a gateway (CAN gateway) that integrates segments of a system formed by a plurality of communication lines 41 of recognition-related onboard ECUs 3, determination-related onboard ECUs 3, and operation-related onboard ECUs 3, and relays communication of the onboard ECUs 3 between these segments. The plurality of communication lines 41 each corresponds to a bus (CAN bus, Ethernet cable) in each segment. The onboard device 2 may be an onboard relay device such as a Layer 2 or Layer 3 Ethernet switch, a PLB (Power Lan Box) that has a power distribution function in addition to a data communication relay function, and an integrated ECU that has a relay function and integrally controls the entire vehicle C. Alternatively, the onboard device 2 may be constituted as one functional unit of the onboard ECUs 3, such as a body ECU that controls a body-related actuator of the vehicle C.

The processing unit 20 is constituted by a CPU (Central Processing Unit), an MPU (Micro Processing Unit) or the like, and is configured to perform various control processing, computational processing and the like, by reading out a control program (program product) and data stored in advance in the storage unit 21 and executing the control program with reference to the data. The processing unit 20 may also be configured to function as a control unit that performs overall control of the onboard device 2, together with performing validity determination of data (CAN messages, IP packets) acquired (received) via the in-vehicle communication unit 23.

The storage unit 21 is constituted by a volatile memory device such as a RAM (Random Access Memory) or a nonvolatile memory device such as a ROM (Read Only Memory), an EEPROM (Electrically Erasable Programmable ROM) or a flash memory, and a program P (program product) and data that is referred to during processing are stored in advance. The program P (program product) stored in the storage unit 21 may be a program P (program product) read out from a recording medium M that is readable by the onboard device 2. Also, the program P (program product) may be downloaded from an external computer (not shown) connected to a communication network (not shown) and stored in the storage unit 21.

The storage unit 21 stores relay route information (routing table) that is used in performing relay processing for communication between the onboard ECUs 3 or communication between the onboard ECUs 3 and the external server 100. The format of the relay route information is determined based on the communication protocol. If the communication protocol is CAN, for example, relay route information for CAN includes a message identifier (CAN-ID, message ID) that is included in the CAN message and a relay destination associated with the CAN-ID (I/O port number of in-vehicle communication unit 23).

The input/output I/F 22 is a communication interface for performing serial communication, for example, similarly to the input/output I/F of the outside communication device 1. For example, via the input/output I/F 22, the onboard device 2 is communicably connected to the outside communication device 1, the display device 5 (HMI device), and an IG switch 6 (or power switch) for starting and stopping the vehicle C.

The in-vehicle communication unit 23 is an input/output interface (CAN driver, Ethernet PHY unit) that uses the CAN (Control Area Network), CAN-FD (CAN with Flexible Data Rate) or Ethernet (registered trademark) communication protocol, for example, and the processing unit 20 communicates with the onboard ECUs 3 or other onboard equipment such as the relay device that are connected to the in-vehicle network 4 via the in-vehicle communication unit 23.

A plurality of in-vehicle communication units 23 are provided, and the communication lines 41 (CAN buses, etc.) constituting the in-vehicle network 4 are connected one-to-one to the in-vehicle communication units 23. The in-vehicle network 4 may be divided into a plurality of segments, by providing the plurality of in-vehicle communication units 23 in this way. The topology type of the in-vehicle network 4 is not limited to a bus topology such as illustrated in the present embodiment, and the topology type may, for example, be a star topology centered on the onboard device 2, a ring topology formed by a plurality of onboard devices 2, or a cascade topology with the onboard device 2 at the top.

The processing unit 20 of the onboard device 2 constituted in this way transitions through a plurality of states in the process of performing determination processing on received data (cyclic data, event data) described later. The plurality of states include, for example, a reference data reception state (reference message acquisition state) in which data (cyclic data) that serves as a reference in specifying the normal cycle range is received, and a determination execution state (cyclic detection execution state) in which the validity of the received data (cyclic data) is determined based on the specified normal cycle range. Processing by the processing unit 20 relating to state transition in the process of performing determination processing may be performed using processing relating to state transition described in International Patent Publication No. WO 2022/185566 (WO/2022/185566), for example.

The onboard ECUs 3 each include a control unit (not shown), a storage unit 21 (not shown) and an in-vehicle communication unit 23 (not shown), similarly to the onboard device 2. The storage unit 21 is constituted by a volatile memory device such as a RAM (Random Access Memory) or a nonvolatile memory device such as a ROM (Read Only Memory), an EEPROM (Electrically Erasable Programmable ROM) or a flash memory, and stores data or programs of the onboard ECU 3. The onboard ECUs 3 transmit CAN messages or IP packets cyclically and communicate with the onboard device 2, for example. The onboard ECUs 3 may be individual ECUs to which a sensor or actuator is connected and that are connected under an integrated ECU.

The display device 5 is an HMI (Human Machine Interface) device such as a car navigation display, for example. The display device 5 is communicably connected to the input/output I/F 22 of the onboard device 2 by a harness such as a serial cable. The display device 5 displays data or information output by the processing unit 20 of the onboard device 2 via the input/output I/F 22.

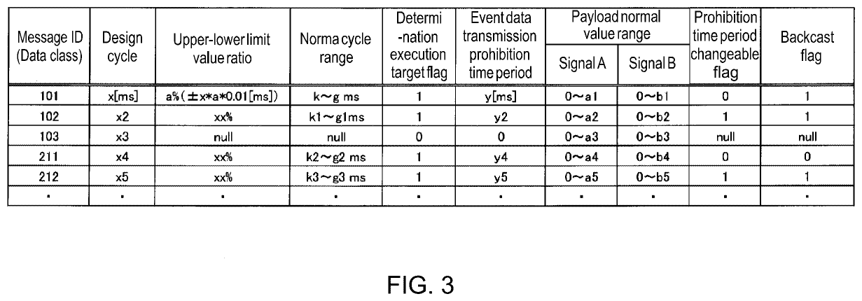

FIG. 3 is an illustrative diagram relating to a data class table. Various data that is referred to by the processing unit 20 when performing determination processing is stored in a predetermined storage area accessible by the processing unit 20, such as the storage unit 21 of the onboard device 2 or a storage device connected to the onboard ECUs 3 or the external server 100. Data classes to be monitored when the processing unit 20 performs determination processing are stored in the storage unit 21 or the like as a data class table constituted in table format, for example. Management items (fields) that are defined in the data class table include message ID (data class), design cycle, upper-lower limit value ratio, normal cycle range, determination execution target flag, event data transmission prohibition time period, payload normal value range, prohibition time period changeable flag, and backcast flag, for example.

In the message ID (data class) management item (field) is stored a message ID (CAN-ID) indicating the class of CAN message, for example. The class of data to be received is determined, based on this message ID. In the case where the data targeted for determination is a CAN message, for example, processing is performed with CAN messages having the same message ID taken as data of the same class. That is, the message ID is set as a management item for classifying or defining the data class. The management item (field) for determining the class of data is not limited to the message ID in CAN messages, and, in the case of TCP/IP packets, for example, may be source IP address, destination IP address, TCP port number, UDP port number or a combination thereof included in the packets.

The design cycle indicates a transmission cycle determined in advance, when data (messages) is transmitted from one of the onboard ECUs 3 or the like, that is, a transmission cycle that is based on design specifications of an application or the like that is implemented in the onboard ECU 3. In the design cycle management item (field) is stored the design cycle (e.g., x [ms]) of individual data.

The upper-lower limit value ratio indicates the upper and lower limit values for specifying the normal cycle range based on the design cycle. The upper-lower limit value ratio may, for example, be defined as a ratio of the design cycle (e.g., a %, where a>0), or may be indicated with an actual time period (±x×a×0.01 [ms]). Alternatively, the upper-lower limit value ratio may differ between the upper limit and lower limit.

The normal cycle range is a range that is calculated using the design cycle and the upper-lower limit value ratio, and is information that is used when determining the validity of received data. For example, if the design cycle is x [ms] and the upper-lower limit value ratio is a% (+x×a×0.01 [ms]), the normal cycle range will be from x−x×a×0.01 [ms] to x+x×a×0.01 [ms]. In the case where the reception time of the reference data that serves as a reference in specifying the normal cycle range is given as (K ms), the median value of the normal cycle range will be (K+x) ms, the lower limit time (limit-low) of the normal cycle range will be {(K+x)−(x×a×0.01)} ms, and the upper limit time (limit-upp) of the normal cycle range will be {(K+x)+(x×a×0.01)} ms. In the present embodiment, the data class table includes both the normal cycle range and the design cycle and upper-lower limit value ratio, but is not limited thereto, and may, needless to say, include only the normal cycle range or the design cycle and upper-lower limit value ratio.

As the determination execution target flag is stored a flag value (1: monitoring target, 0: non monitoring target) for determining which class of data to target for execution of validity determination (monitoring target), out of the data transmitted and received over the in-vehicle network 4. By taking data of the class for which the determination execution target flag is set as data targeted for validity determination (monitoring target), out of data transmitted and received over the in-vehicle network 4, in this way, only data having a comparatively high degree of importance will be taken as a monitoring target, enabling the processing load on the onboard device 2 (processing unit 20) to be reduced.

As the event data transmission prohibition time period is stored a value for setting a time period (period) in which transmission of event data is prohibited from the reception time of reference data (reference message) for specifying the normal cycle range, that is, the cyclic data received first, for the message ID (data class) stored in the same record. That is, the start time of the period in which transmission of event data is prohibited (event data transmission prohibition period) is the reception time of the cyclic data received first, and the end time of the event data transmission prohibition period is the time at which the event data transmission prohibition time period elapses from the reception time of the first cyclic data. The event data transmission prohibition time period is a shorter time period (smaller value) than the design cycle (event data transmission prohibition time period <design cycle). The event data transmission prohibition time period may be set using a coefficient (K) that is less than 1 such as 0.4, for example, with respect to the design cycle (event data transmission prohibition time period=design cycle×K: e.g., K=0.4). As will be described in detail later, data (event data) received in the event data transmission prohibition period is determined to be anomalous (anomaly detected (specific)). Furthermore, the event data transmission prohibition time period may also be used with respect to two pieces of consecutively received event data. Validity determination in terms of the event data transmission prohibition time period (event data transmission prohibition period) performed on two pieces of consecutively received event data will be described later.

As the payload normal value range is stored a range of possible values of a signal value, control value or the like that is included in the payload area of the message ID (data class) stored in the same record. The range of possible values of the signal value, control value or the like is a range determined in advance based on product specifications of various applications or the like that detect or calculate those values. As will be described later, when the value stored in the payload area of received event data exceeds the payload normal value range, the event data is determined to be anomalous (anomaly detected (specific)).

A plurality of values may be defined (stored) in the payload normal value range, according to the signals included in the payload area. In the present embodiment, the payload area includes two signals (signal A and signal B), and a normal value range may be defined for each of these signals (normal value range of signal A and normal value range of signal B).

The processing unit 20 of the onboard device 2 may, in performing validity determination that is based on the payload value of received event data, be configured to determine whether each signal value included in the payload area is within the normal value range. At this time, even if only one of the plurality of signal values included in the payload area exceeds the normal value range, the processing unit 20 of the onboard device 2 may be configured to determine that the received event data is anomalous (anomaly detected (specific)).

As the prohibition time period changeable flag, a flag value (fix: 0, shorten: 1) for determining whether the event data transmission prohibition period (event data transmission prohibition time period) is to be fixed or is to be changed (shortened) so as to avoid overlapping with the normal cycle range is stored. In the case where the event data transmission prohibition period overlaps with the normal cycle range, the processing unit 20 of the onboard device 2 determines whether the event data transmission prohibition period (event data transmission prohibition time period) is to be fixed or is to be changed (shortened) so as to avoid overlapping with the normal cycle range, based on the prohibition time period changeable flag (fix: 0, shorten: 1) defined in the data class table.

As the backcast flag is stored a flag value (suspend: 0, continue: 1) for determining, in the case where any of the event data was determined to be anomalous when backcast processing was executed, whether backcast processing is to be continued on all of the event data or is to be suspended. Based on the backcast flag (suspend: 0, continue: 1) defined in the data class table, the processing unit 20 of the onboard device 2 determines, in the case where any of the event data was determined to be anomalous, whether to continue the backcast processing on all of the event data or whether to suspend the backcast processing.

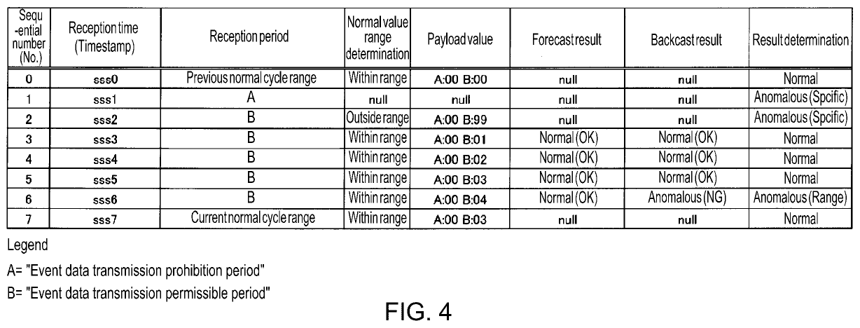

FIG. 4 is an illustrative diagram relating to a data reception list. When data targeted for validity determination is received, the processing unit 20 of the onboard device 2 stores information relating to the data in list format (data reception list) or table format in a predetermined storage area that is accessible, such as the storage unit 21. The processing unit 20 of the onboard device 2 may, when storing information relating to received data in the data reception list, for example, be configured to store the information in different lists, according to the data class. The data reception lists generated and stored according to the data class in this way are saved and managed as log information (reception log) of received data.

The data reception list that is in list format (table format) is, for example, saved and managed as a different list for each data class. The data reception list for each data class includes, for example, sequential number (No.), reception time (timestamp), reception period, normal value range determination, payload value, forecast result, backcast result, and result determination as management items (fields).

In the sequential number (No.) management item is stored a number (sequential number) indicating the order in which the data was received. In the present embodiment, the sequential number of the reference data (reference message) for specifying the normal cycle range, that is, the cyclic data received first, is set (stored) as 0. After receiving the first cyclic data, the value of the sequential number is incremented (increased by one) and set (stored), every time data of the same class as the first cyclic data is received.

In the reception time (timestamp) management item is stored a reception time indicating the time at which data having the sequential number (No.) stored in the same record was received. By calculating the difference (time difference) between the respective reception times of the data, on the basis of the reception time of the data whose sequential number is set as 0 (cyclic data received first), the processing unit 20 of the onboard device 2 is able to specify whether the data was received in any of the event data transmission prohibition period, an event transmission permissible period (event data transmission permissible period), or the normal cycle range. Furthermore, by calculating the difference (time difference) between the reception time of event data received first and the reception time of event data received second, out of two pieces of event data having consecutive reception times, the processing unit 20 of the onboard device 2 is able to determine whether the interval of these reception times is less than or equal to the event data transmission prohibition time period.

As the reception period is stored a period that includes the reception time of data having the sequential number (No.) stored in the same record. As this period, the normal cycle range that includes the reception time of the reference data (reference message) included in the previous normal cycle range, that is, the cyclic data received first (previous normal cycle range) is followed temporally by the event data transmission prohibition period, the event transmission permissible period, and the current normal cycle range in the stated order. The event data transmission prohibition period and the current normal cycle range are determined according to the normal cycle range and event data transmission prohibition time period defined in the data class table, for example, on the basis of the reception time of the cyclic data received first. The event transmission permissible period (event data transmission permissible period) is the period interposed between the event data transmission prohibition period and the current normal cycle range.

The processing unit 20 of the onboard device 2 specifies whether received data is event data or cyclic data, according to which period the reception time of the data belongs. Data received in the event data transmission prohibition period set on the basis of the reception time of the cyclic data received first or in the event transmission permissible period, that is, data received outside the normal cycle range, is determined as event data. Data received within the normal cycle range is determined as cyclic data.

In the normal value range determination management item is stored whether the payload value, that is, the individual signal values, of data having the sequential number (No.) stored in the same record is within the payload normal value range defined in the data class table or not (within the range or outside the range). Note that event data received in the event data transmission prohibition period may be data on which processing relating to the payload value has not been performed.

In the payload value management item is stored the payload value, that is, individual signal values, of data having the sequential number (No.) stored in the same record. Note that event data received in the event data transmission prohibition period may be data on which processing relating to the payload value has not been performed.

In the forecast result management item is stored the determination result of forecast processing on data (event data) received in the event transmission permissible period. The forecast processing will be described in detail later.

In the backcast result management item is stored the determination result of backcast processing on data (event data) received in the event transmission permissible period. The backcast processing will be described in detail later.

In the result determination management item is stored the final result determination that depends on the forecast result for data (event data) received in the event transmission permissible period, or a combination of the forecast result and the backcast result. The result determination is, for example, normal or anomalous, and the anomalous result includes anomaly detected (range) “anomalous (range)” indicating a state in which it is detected that an anomaly is included in a certain reception range, and anomaly detected (specific) “anomalous (specific)” indicating a state in which the data (message) that is anomalous was specified. The result determination will be described in detail later.

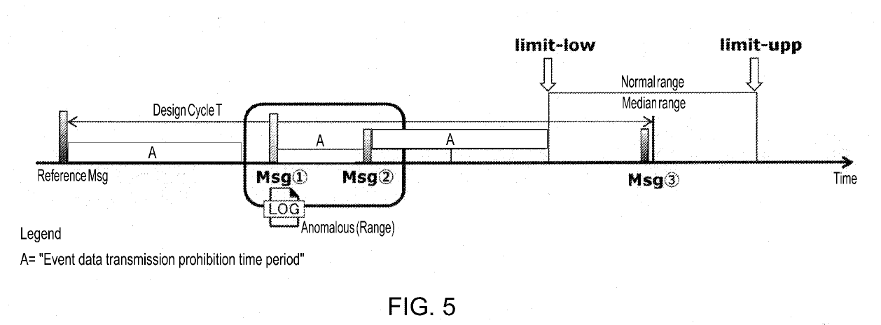

FIG. 5 is an illustrative diagram relating to validity determination of event data (event data transmission prohibition period). In the illustrative example of the present embodiment, determination processing relating to data (CAN messages, etc.) of a specific data class will be described. In this illustrative example, the horizontal axis indicates time (elapsed time). The processing unit 20 of the onboard device 2 calculates the reception interval of data of the same class (same message ID) for each piece of data (monitoring target message) defined in the data class table that is stored in the storage unit 21, for example, and, if the reception interval is within the normal cycle range, determines (specifies) that the data (periodic message) is cyclic data that is transmitted cyclically. Validity determination of cyclic data and determination of the normal cycle range may be similar to the processing relating to data (corresponds to cyclic data) described in International Patent Publication No. WO 2022/185566(WO/2022/185566 ), for example.

In the illustrative example of the present embodiment, the first cyclic data (reference Msg) is determined to be normal, and the event data transmission prohibition period and the normal value range are determined on the basis of the reception time of the first cyclic data (reference Msg). The event data transmission prohibition period is the period from the reception time of the first cyclic data (reference Msg) to when the event data transmission prohibition time period elapses. The processing unit 20 of the onboard device 2 calculates (specifies), as the normal cycle range (current normal cycle range), a period whose median value is a time obtained by adding the design cycle (T) to the reception time of the first cyclic data (reference Msg), and whose upper and lower limits are upper limit time (limit-upp) and lower limit time (limit-low). Data (Msg3) received in the normal cycle range (current normal cycle range) is handled as cyclic data (Msg3) received second. In the illustrative example of the present embodiment, the number of pieces of data received in the current normal cycle range is only one, namely, the cyclic data (Msg3) received second, and the payload value (all signal values) of the cyclic data (Msg3) is within the normal value range, and thus it is determined that the cyclic data (Msg3) received second is normal.

Two pieces of data (Msg1, Msg2) are received in the period from the reception time of the first cyclic data (reference Msg) to the lower limit time (limit-low) of the current normal cycle range. These two pieces of data (Msg1, Msg2) are handled as event data and undergo validity determination. It is determined whether event data targeted for determination is included in the event data transmission prohibition period that starts from the reception time of the piece of data received directly therebefore (first cyclic data or event data). The reception time of the received data (Msg1) is not included in the event data transmission prohibition period that starts from the reception time of the first cyclic data (reference Msg) received directly before the data (Msg1). That is, the interval from the reception time of the first cyclic data (reference Msg) to the reception time of the data (Msg1) is longer than the event data transmission prohibition period. Accordingly, the processing unit 20 of the onboard device 2 determines that the data (Msg1) received outside the event data transmission prohibition period is normal event data in terms of transmission characteristics (transmission timing) that take the event data transmission prohibition time period into consideration.

The reception time of the received data (Msg2) is included in the event data transmission prohibition period that starts from the reception time of the data (Msg1) received directly before the data (Msg2). That is, out of two pieces of event data (Msg1, 2) having consecutive reception times, the interval from the reception time of the earlier event data (Msg1) to the reception time of the later event data (Msg2) is less than or equal to the event data transmission prohibition period. Accordingly, the processing unit 20 of the onboard device 2 determines that the data (Msg2) received within the event data transmission prohibition period is anomalous event data. At this time, the processing unit 20 of the onboard device 2 may be configured to determine that the event data (Msg2) corresponds to anomaly detected (specific) “anomalous (specific)”.

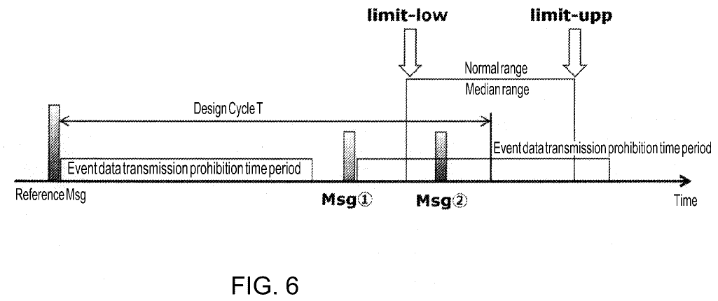

FIG. 6 is an illustrative diagram relating to the event data transmission prohibition period (fixed) of event data. In setting the event data transmission prohibition period that starts from the reception time of the event data (Msg1), the processing unit 20 of the onboard device 2 fixedly uses the event data transmission prohibition time period defined according to the data class in the data class table, for example. In this case, the event data transmission prohibition period (event data transmission prohibition time period) that starts from the reception time of the event data (Msg1) overlaps with the current normal cycle range. In the illustrative example of the present embodiment, the data (Msg2) is received in a period in which the event data transmission prohibition period overlaps with the normal cycle range.

Even if the event data transmission prohibition period overlaps with the normal cycle range in this way, the processing unit 20 of the onboard device 2 may be configured to prioritize the event data transmission prohibition period in determining the validity of the data (Msg2). That is, the processing unit 20 of the onboard device 2 may be configured to determine that the data (Msg2) whose reception time is included in the period in which the event data transmission prohibition period overlaps with the normal cycle range corresponds to anomaly detected (specific) “anomalous (specific)”. As a result of the event data transmission prohibition period (event data transmission prohibition time period) being fixedly set (the same value determined in advance being used), regardless of whether there is overlap between the event data transmission prohibition period and the normal cycle range, logic design relating to the determination processing can be simplified, and the processing load on the processing unit 20 can be suppressed.

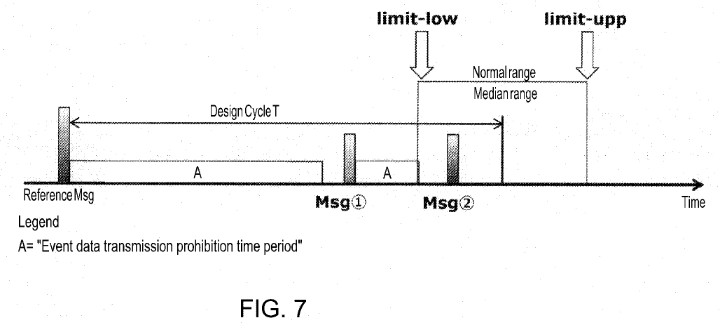

FIG. 7 is an illustrative diagram relating to the event data transmission prohibition period (variable) of event data. In setting the event data transmission prohibition period that starts at the reception time of the event data (Msg1), the processing unit 20 of the onboard device 2 changes the event data transmission prohibition period (event data transmission prohibition time period), according to whether there is overlap with the normal cycle range, while using the event data transmission prohibition time period defined according to the data class in the data class table, for example, as an initial value.

When the event data transmission prohibition period that starts at the reception time of the event data (Msg1) overlaps with the normal cycle range, due to using the event data transmission prohibition time period defined in advance in the data class table, the processing unit 20 of the onboard device 2 avoids the overlap, by shortening the event data transmission prohibition time period defined in advance. That is, the processing unit 20 of the onboard device 2 shortens the event data transmission prohibition period (event data transmission prohibition time period) by setting the end time of the event data transmission prohibition period that starts at the reception time of the event data (Msg1) to before the start time (lower limit time (limit-low)) of the normal cycle range. In this case, the reception time of the data (Msg2) is included only in the normal cycle range and is not included in the event data transmission prohibition period that starts from the reception time of the event data (Msg1). Accordingly, the data (Msg2) is determined to be normal cyclic data, in the case where the data (Msg2) is handled as cyclic data and is the only data received within the normal cycle range.

The present disclosure is not limited to the case where, when the event data transmission prohibition period overlaps with the normal cycle range, it is uniformly determined in the onboard system S whether the event data transmission prohibition period (event data transmission prohibition time period) is to be fixed or is to be changed (shortened) so as to avoid overlapping with the normal cycle range. The processing unit 20 of the onboard device 2 may, in the case where the event data transmission prohibition period overlaps with the normal cycle range, be configured to determine whether the event data transmission prohibition period (event data transmission prohibition time period) is to be fixed or is to be changed (shortened) so as to avoid overlapping with the normal cycle range, based on the prohibition time period changeable flag (fix: 0, shorten: 1) defined in the data class table, for example.

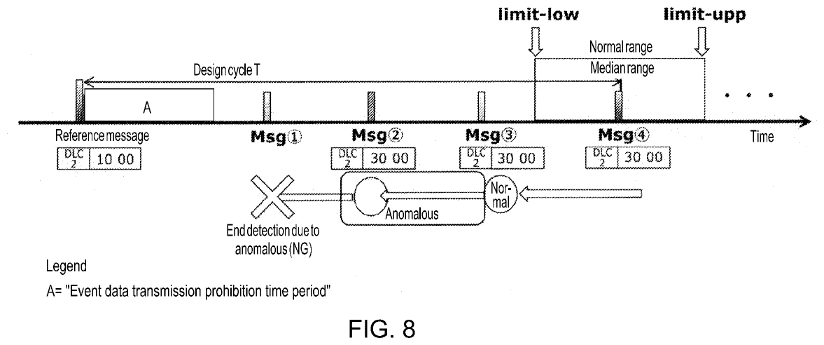

FIG. 8 is an illustrative diagram relating to validity determination of event data (backcast: pattern 1). In the illustrative example of the present embodiment, the cyclic data (reference Msg) received first and the cyclic data (Msg4) received second are both determined to be normal. That is, since the cyclic data (Msg4) received second is the only data of the same class received in the normal cycle range set on the basis of the reception time of the cyclic data (reference Msg) received first and the payload value thereof is within the normal value range, the cyclic data (Msg4) is determined to be normal. Event data (Msg3) is received within the event transmission permissible period, and the payload value (signal values) thereof is also within the normal value range. Furthermore, the payload value (signal values) of the event data (Msg3) is the same (practically the same value) as the payload value (signal values) of the cyclic data (Msg4) received second.

Event data has the transmission characteristic of being transmitted in an event-driven manner, when a phenomenon (event) occurs such as a change in the payload value of data (cyclic data or event data) transmitted directly therebefore. In contrast, cyclic data is transmitted in a cyclical manner, in the case where a phenomenon (event) such as a change in the payload value of data (cyclic data or event data) transmitted directly therebefore has not occurred. Accordingly, it is assumed that the payload value (signal values) of event data received directly before the reception time of cyclic data will match (be substantively the same as) the payload value (signal values) of the cyclic data. In data of the same class, the payload value of event data and the payload value of the cyclic data received directly after the event data being different values (not being substantively the same value) is contrary to the above transmission characteristic, and the values being the same (practically the same value) is compatible with the above transmission characteristic. Determination as to whether the values match (are substantively the same), may be performed using the threshold value for difference determination determined in advance.

As for the processing unit 20 of the onboard device 2 determining the validity of event data based on the sameness of the payload value of the cyclic data and the payload value of the event data, determination of the sameness need not be limited to the case where the values are perfectly matched. The processing unit 20 of the onboard device 2 may be configured to determine that the event data is anomalous if the difference in payload value (signal values) between the cyclic data and the event data is less than or equal to a predetermined value (payload values substantively the same), and to determine that the event data is normal if the difference in payload value (signal values) between the cyclic data and the event data exceeds the predetermined value (payload values not substantively the same). If the predetermined value is 0, this indicates perfect matching of the payload values (signal values), but by setting the predetermined value to a comparatively small value close to 0, for example, it is possible to flexibly respond to transmission characteristics that are determined by the data class of the event data. That is, the predetermined value (threshold value for difference determination) used in comparison (difference determination) of payload values (signal values) may be individually set with a data class table, for example, according to the data class or the like of event data that is transmitted in an event-driven manner.

The processing unit 20 of the onboard device 2 performs comparative processing (backcast processing) with the payload value (signal values) of the cyclic data (Msg4) received second and the payload value (signal values) of the event data (Msg3) received last in the event transmission permissible period. The processing unit 20 of the onboard device 2 determines that event data having a different payload value from the payload value of cyclic data received directly thereafter is anomalous. The processing unit 20 of the onboard device 2 determines that event data having the same (substantively the same) payload value as the payload value of cyclic data received directly thereafter is normal. Since the payload value (signal values) of the event data (Msg3) is the same (practically the same value) as the payload value (signal values) of the cyclic data (Msg4) received second, the processing unit 20 of the onboard device 2 determines that the event data (Msg3) is normal.

The processing unit 20 of the onboard device 2, furthermore, also determines the validity of the event data (Msg2) received before the event data (Msg3) determined to be normal, by continuing the backcast processing. The data for comparison with the event data (Msg2) which is the determination target, that is, the data that was received directly after the reception time of the event data (Msg2) and was determined to be normal, is the event data (Msg3). As described above, event data has the transmission characteristic of being transmitted in an event-driven manner, when a phenomenon (event) occurs such as a change in the payload value of data (cyclic data or event data) transmitted directly therebefore, and thus it is assumed that the payload values (signal values) of two pieces of event data whose reception times are consecutive will be different (not substantively the same). That is, in data of the same class, the payload value of event data and the payload value of event data received directly thereafter being different values (not substantively the same value) is compatible with the above transmission characteristic, and the values being the same (practically the same value) is contrary to the above transmission characteristic.

The processing unit 20 of the onboard device 2 determines that event data having a different payload value from the payload value of normal event data received directly thereafter is normal. The processing unit 20 of the onboard device 2 determines that event data having the same (substantively the same) payload value as the payload value of normal event data received directly thereafter is anomalous. Since the payload value (signal values) of the event data (Msg2) and the payload value (signal values) of the event data (Msg3) received directly thereafter and determined to be normal are the same (practically the same value), the processing unit 20 of the onboard device 2 determines that the event data (Msg2) is anomalous. The processing unit 20 of the onboard device 2 may be configured to determine that the event data (Msg2) is anomaly detected (range) “anomalous (range)”.

In retrospectively performing backcast processing sequentially on event data from the event data received last in this way, the processing unit 20 of the onboard device 2 suspends the backcast processing if any of the event data is determined to be anomalous. Accordingly, the processing unit 20 of the onboard device 2 does not perform validity determination by backcast processing on event data (Msg1) received before the event data (Msg2) determined to be anomalous.

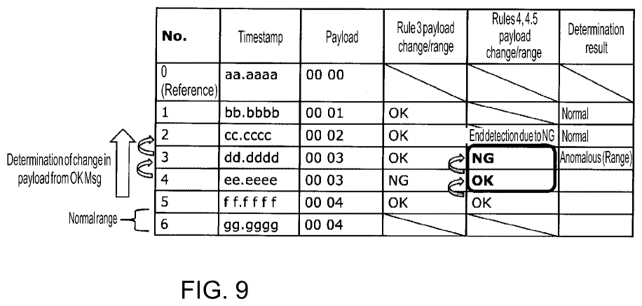

FIG. 9 is an illustrative diagram relating to validity determination of event data (payload change: pattern 1). As shown in the illustrative example of the present embodiment, forecast processing on the basis of the cyclic data received first and backcast processing on the basis of the cyclic data received second are performed on received event data. If, in retrospectively performing the backcast processing sequentially on the event data from the event data received last (No. 5), it is determined that any of the event data (No. 3) is anomalous, the backcast processing is suspended. Validity determination by backcast processing is not performed on the event data (Nos. 2, 1) received before the event data (No. 3) determined to be anomalous. Based on the results (OK, NG) of the forecast processing and the backcast processing, the processing unit 20 of the onboard device 2 determines the final determination result using a determination table described later, based on the combination of these results.

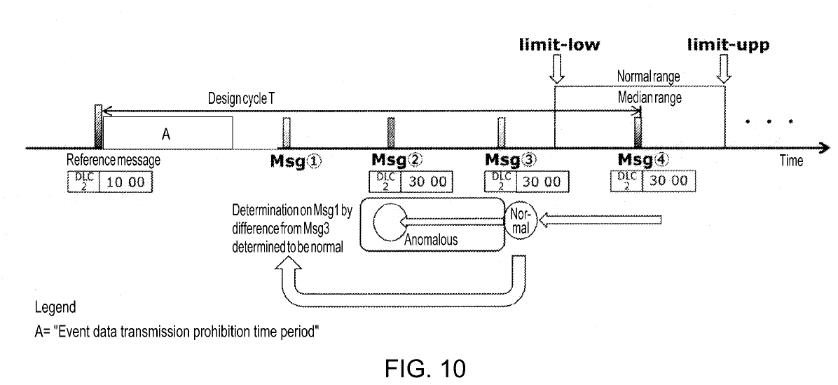

FIG. 10 is an illustrative diagram relating to validity determination of event data (backcast: pattern 2). The processing unit 20 of the onboard device 2 performs validity determination by backcast processing on the event data (No. 3) and the event data (No. 2), similarly to that illustrated in FIG. 9. Even if it is determined that the event data (No. 2) is anomalous, the processing unit 20 of the onboard device 2 continues the backcast processing and performs validity determination on the event data (No. 1). That is, the processing unit 20 of the onboard device 2 determines the validity of the event data (No. 1), by the difference from (contrast with) the event data (No. 3) determined to be normal. Accordingly, the data for comparison with the event data (No. 1) targeted for determination, that is, the data received directly after the reception time of the event data (No. 1) targeted for determination and determined to be normal is the event data (No. 3).

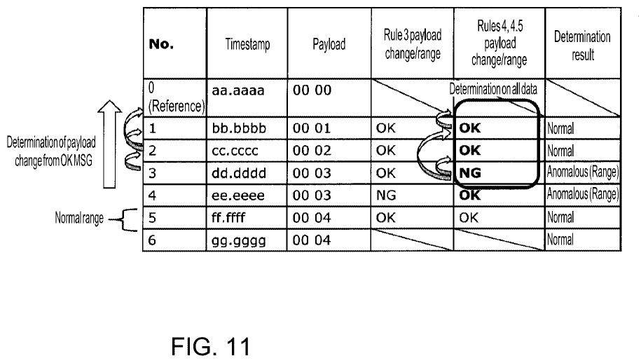

FIG. 11 is an illustrative diagram relating to validity determination of event data (payload change: pattern 2). In retrospectively performing backcast processing sequentially on the event data from the event data received last (No. 5), the backcast processing is continued even if any of the event data (No. 3) is determined to be anomalous. Validity determination by backcast processing is thereby also performed on the event data (Nos. 2, 1) received before the event data (No. 3) determined to be anomalous, and backcast processing on all of the received event data (Nos. 5, 4, 3, 2, 1) is performed. Validity determination is performed on the event data (No. 2) received directly before the reception time of the event data (No. 3) determined to be anomalous, by comparison with the payload value of the event data (No. 4) determined to be normal. That is, the data received directly before the event data (No. 2) targeted for determination and determined to be normal is the event data (No. 4).

The present disclosure is not limited to uniformly determining in the onboard system S whether to continue the backcast processing on all of the event data or whether to suspend the backcast processing, in the case where any of the event data is determined to be anomalous. The processing unit 20 of the onboard device 2 may, in the case where any of the event data is determined to be anomalous, be configured to determine whether to continue the backcast processing on all of the event data or whether to suspend the backcast processing, based on the backcast flag (suspend: 0, continue: 1) defined in the data class table, for example.

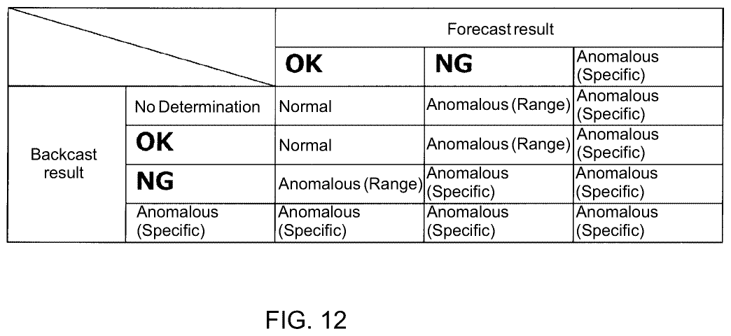

FIG. 12 is an illustrative diagram (matrix table) relating to the determination mode (determination table) for event data used by the processing unit 20 of the onboard device 2. The processing unit 20 of the onboard device 2 performs, on one or more pieces of event data received in the event transmission permissible period (outside the event data transmission prohibition period) and whose payload value is within the normal value range, processing such as determination (forecast processing) that is based on whether there is a change from the payload value of the cyclic data received first and determination (backcast processing) that is based on the sameness with the payload value of the cyclic data received second.

In this case, for example, both types of determination processing, namely, forecast processing and backcast processing, are performed on the one or more pieces of event data received in the event transmission permissible period (outside the event data transmission prohibition period) and whose payload value is within the normal value range. At this time, the processing unit 20 of the onboard device 2 may be configured to combine the results of the forecast processing and the backcast processing to derive the final result determination. With respect to event data on which only forecast processing was performed, the processing unit 20 of the onboard device 2 may be configured to derive the final result determination, based on the forecast processing. In deriving the final result determination, the processing unit 20 of the onboard device 2 may be configured to derive a determination mode (final result determination) for the event data, using the determination table shown in matrix table format, for example.

The determination table is stored in a predetermined storage area accessible by the processing unit 20, such as the storage unit 21. The determination table in matrix format includes forecast results which are vertical management items and backcast results which are horizontal management items.

The forecast result includes items “OK” (normal), “NG” (anomalous), and “anomalous (specific)” as specific items. The forecast result being “OK” (normal) indicates that the determination result of the forecast processing is normal. The forecast result being “NG” (anomalous) indicates that the determination result of the forecast processing is anomalous, that is, there is no change in the payload value (signal values) of the event data targeted for determination. The forecast result being “anomalous (specific)” indicates that the payload value (signal values) of the event data targeted for determination exceeds the normal value range.

The backcast result includes items “no determination”, “OK” (normal), “NG” (anomalous), and “anomalous (specific)” as specific items. The backcast result being “no determination” indicates that backcast processing was not executed on the event data targeted for determination. The backcast result being “OK” (normal) indicates that the determination result of the backcast processing is normal. The backcast result being “NG” (anomalous) indicates that the determination result of the backcast processing is anomalous, that is, that the payload value (signal values) of the event data targeted for determination is a different value from (not substantively the same value as) the payload value of the cyclic data received directly thereafter. Alternatively, in the case where the data received directly after the event data targeted for determination and determined to be normal is other event data, the backcast result will also be NG (anomalous) if the payload value (signal values) of the event data targeted for determination is the same value (substantively the same value) as the payload value of the other event data. The backcast result being “anomalous (specific)” indicates that the payload value (signal values) of the event data targeted for determination exceeds the normal value range.

The processing unit 20 of the onboard device 2 derives the final result determination, based on a combination of the specific item of the forecast result and the specific item of the backcast result. In the case where the backcast result is “no determination”, the final result determination when the forecast result is OK (normal) will be “normal”, the final result determination when the forecast result is NG (anomalous) will be “anomaly detected (range)”, and the final result determination when the forecast result is anomalous (specific) will be “anomaly detected (specific)”.

In the case where the backcast result is “OK” (normal), the final result determination when the forecast result is OK (normal) will be “normal”, the final result determination when the forecast result is NG (anomalous) will be “anomaly detected (range)”, and the final result determination when the forecast result is anomalous (specific) will be “anomaly detected (specific)”. That is, when the backcast result and the forecast result differ between OK (normal) and NG (anomalous), the final result determination will be “anomaly detected (range)”.

In the case where the backcast result is “NG (anomalous)”, the final result determination when the forecast result is OK (normal) will be “anomaly detected (range)”, the final result determination when the forecast result is NG (anomalous) will be “anomaly detected (specific)”, and the final result determination when the forecast result is anomalous (specific) will be “anomaly detected (specific)”. That is, when the backcast result and the forecast result are both NG (anomalous), the final result determination will be “anomaly detected (specific)”.

In the case where the backcast result is “anomalous (specific)”, the final result determinations will all be anomaly detected (specific), regardless of the forecast result. The backcast result or forecast result being “anomalous (specific)” indicates that the payload value (signal values) of the event data targeted for determination exceeds the normal value range. In this case, the processing unit 20 of the onboard device 2 may be configured to determine that the event data targeted for determination is anomalous, that is, data corresponding to anomaly detected (specific), without comparing the payload value (signal values) of the event data targeted for determination with other data (cyclic data or event data).

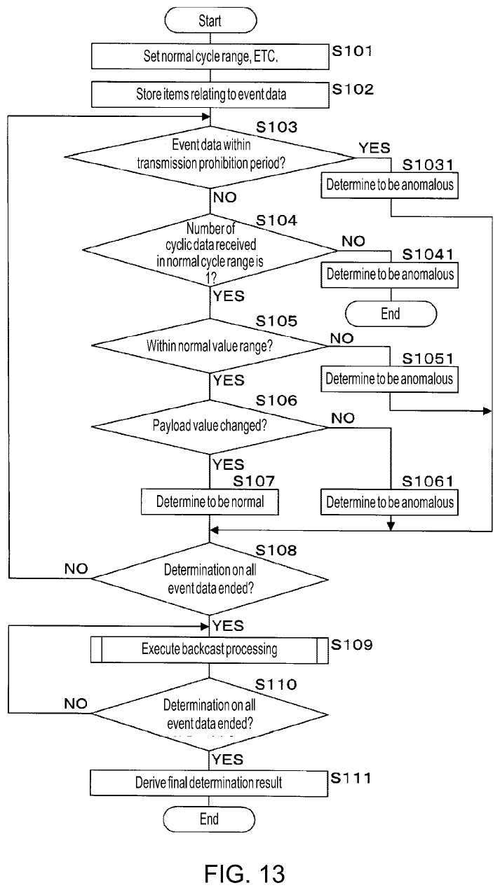

FIG. 13 is a flowchart (main processing) illustrating processing by the processing unit 20 of the onboard device 2. The processing unit 20 of the onboard device 2 regularly performs the following processing in a state where, for example, the vehicle C has started up (IG switch 6 or power switch is on) or stopped (IG switch 6 or power switch is off).

The processing unit 20 of the onboard device 2 sets the event data transmission prohibition period and the normal cycle range, based on received cyclic data (reference data) that serves as a reference (S101). Every time cyclic data transmitted cyclically is received, the processing unit 20 of the onboard device 2 determines whether the received cyclic data is normal. The processing unit 20 of the onboard device 2 sets the event data transmission prohibition period and the normal cycle range (current normal cycle range), based on the reception time of cyclic data (reference data) determined to be normal, with reference to the data class table, for example.

The processing unit 20 of the onboard device 2 stores items relating to received event data in the storage unit 21 (S102). The processing unit 20 of the onboard device 2 stores items (sequential number, reception time, etc.) relating to event data received in the period from the reception time of the received cyclic data (reference data) serving as a reference to the lower limit time (limit-low) of the set normal cycle range in the storage unit 21 in list format (data reception list), for example. The processing unit 20 of the onboard device 2 may be configured to also store cyclic data received in the normal cycle range in the storage unit 21, by storing (adding) the cyclic data in the data reception list.

The period from the reception time of the received cyclic data (reference data) serving as a reference to the lower limit time (limit-low) of the set normal cycle range includes the event data transmission prohibition period in which event transmission is prohibited and the event transmission permissible period in which event transmission is permitted. The event data transmission prohibition period that starts at the reception time of the first cyclic data (reference data) and the event transmission permissible period are temporally continuous, that is, the event transmission permissible period starts directly after the event data transmission prohibition period ends. The period of the normal cycle range starts directly after the end of the event transmission permissible period. The event data transmission prohibition period is set using not only by the reception time of the first cyclic data but also the reception time of the event data.

The processing unit 20 of the onboard device 2 acquires the data received during the event data transmission prohibition period and the event transmission permissible period as event data (Msg outside normal cycle range) targeted for validity determination. The event data transmission prohibition period and the event transmission permissible period correspond to periods outside the normal cycle range. The processing unit 20 of the onboard device 2 acquires the data received within the normal cycle range as cyclic data (Msg within normal cycle range) targeted for validity determination. Even if data is not received within the normal cycle range, that is, even if the number of data received within the normal cycle range is 0, the processing unit 20 of the onboard device 2 executes subsequent processing after the period determined as the normal cycle range elapses.

The processing unit 20 of the onboard device 2 determines whether the reception time of the received event data is within the event data transmission prohibition period (S103). The start time of the event data transmission prohibition period, with respect to the event data targeted for determination, will be the reception time of the cyclic data received first or the reception time of other event data received directly before the reception time of the event data targeted for determination. Accordingly, when determination of the plurality of received event data is performed sequentially in the order in which the event data was received (in order of reception time from oldest to most recent), the start time of the event data transmission prohibition period corresponding to the event data on which determination is initially performed will be the reception time of the cyclic data received first. Thereafter, when determination is performed sequentially on a plurality of event data in order of reception time from oldest to most recent, the start time of the event data transmission prohibition period corresponding to the event data targeted for determination will be the reception time of other event data received directly before the reception time of the event data targeted for determination. Validity determination that takes the transmission characteristics of the plurality of received event data into consideration can be appropriately performed on the received event data, by individually setting the event data transmission prohibition period and the event transmission permissible period using the respective reception times of the event data in this way, rather than the event data transmission prohibition period and the event transmission permissible period being determined based only on the reception time of the cyclic data received first.

The event data transmission prohibition period that starts at the respective reception times of the event data is determined, based on the value stored for the event data transmission prohibition time period that depends on, for example, the data class defined in the data class table. The processing unit 20 of the onboard device 2 is not limited to fixedly using the event data transmission prohibition time period defined in the data class table. The processing unit 20 of the onboard device 2 may, in the case where the event data transmission prohibition period (event data transmission prohibition time period) that starts at the reception time of any of the event data overlaps with the normal cycle range, be configured to shorten the event data transmission prohibition period. That is, the processing unit 20 of the onboard device 2 may be configured to shorten the event data transmission prohibition period (event data transmission prohibition time period), by setting the end time of the event data transmission prohibition period that starts at the reception time of the event data to before the start time (lower limit time (limit-low)) of the normal cycle range. The processing unit 20 of the onboard device 2 may be configured to determine whether the event data transmission prohibition period (event data transmission prohibition time period) is to be fixed or is to be changed (shortened) so as to avoid overlapping with the normal cycle range, according to prohibition time period changeable flag included in the data class table, for example. By individually setting whether to fix or change (shorten) the event data transmission prohibition period according to the data class of event data in this way, validity determination of a plurality of received event data with consideration for the transmission characteristics of the event data can be appropriately performed.

If the reception time of the event data is within the event data transmission prohibition period (S103: YES), the processing unit 20 of the onboard device 2 determines that the event data is anomalous (anomaly detected (specific)) (S1031). When the reception time of the event data targeted for determination is within the event data transmission prohibition period that starts from the reception time of the data (cyclic data received first or event data) received directly before the event data targeted for determination, the interval between the reception time of the event data targeted for determination and the reception time of the data received directly before the event data targeted for determination will be less than or equal to the event data transmission prohibition period (event data transmission prohibition time period). In this case, the processing unit 20 of the onboard device 2 determines that the event data is anomalous (anomaly detected (specific)).

If the reception time of the event data is not within the event data transmission prohibition period (S103: NO), that is, if the reception time of the event data is within the event transmission permissible period, the processing unit 20 of the onboard device 2 determines whether the number of cyclic data received in the normal cycle range is one (S104). When the reception time of the event data targeted for determination is not within the event data transmission prohibition period that starts from the reception time of the data (cyclic data received first or event data) received directly before the event data targeted for determination, the interval between the reception time of the event data targeted for determination and the reception time of the data received directly before the event data targeted for determination will be longer than the event data transmission prohibition period (event data transmission prohibition time period). In this case, the processing unit 20 of the onboard device 2 may be configured to provisionally determine that the event data is normal in terms of transmission characteristics (transmission timing) that take the event data transmission prohibition time period into consideration, and to store information to the effect that the event data was determined to be normal in the storage unit 21.

If the number of cyclic data acquired in the normal cycle range is not one (S104: NO), that is, if the number of cyclic data acquired in the normal cycle range is 0 (none) or more than one, the processing unit 20 of the onboard device 2 determines that the received event data and plurality of cyclic data are anomalous (anomaly detected (range)) (S1041). Alternatively, the processing unit 20 of the onboard device 2 may, in the case where the number of cyclic data acquired in the normal cycle range is 0 (none) or more than one, be configured to determine that event data received in the event data transmission prohibition period is anomaly detected (specific). In this case, the processing unit 20 of the onboard device 2 may be configured to perform, on event data received in the event transmission permissible period, determination processing that depends on, for example, the data class of the event data.

If the number of cyclic data acquired in the normal cycle range is one (S104: YES), the processing unit 20 of the onboard device 2 determines whether the payload value of the event data targeted for determination is within the normal value range (S105). When the number of cyclic data acquired in the normal cycle range (current normal cycle range) is one and the payload value of the acquired cyclic data is within the normal value range, the processing unit 20 of the onboard device 2 determines that the cyclic data is normal. The two pieces of consecutively received cyclic data (cyclic data received first and cyclic data received second) are thereby both normal, and a precondition for starting determination processing based on comparison with the payload values of the cyclic data on one or more pieces of event data received between the reception times of these two pieces of cyclic data may be satisfied.

The processing unit 20 of the onboard device 2 starts the determination processing sequentially from the event data with the oldest reception time, or in other words, the event data whose reception time is closest to the cyclic data (reference data) received first, with reference to the data reception list stored in the storage unit 21. That is, the event data received directly after the cyclic data (reference data) that serves as a reference corresponds to the event data with the oldest reception time.

If not within the normal value range (S105: NO), the processing unit 20 of the onboard device 2 determines that the event data targeted for determination is anomalous (anomaly detected (specific)) (S1051). When the payload value of the event data targeted for determination is not within the normal value range, that is, when any of the signal values included in the payload area of the event data is not within the normal value range, the processing unit 20 of the onboard device 2 determines that the event data targeted for determination is anomalous (anomaly detected (specific)).

If within the normal value range (S105: YES), the processing unit 20 of the onboard device 2 determines whether the payload value of the event data targeted for determination is different from the payload value of the data received directly therebefore and determined to be normal, that is, whether the payload value has changed (S106). When the payload value of the event data targeted for determination is within the normal value range (all signal values within normal value range), the processing unit 20 of the onboard device 2 sequentially performs, on the individual pieces of event data, processing (forecast processing) for determining whether the payload value of the event data targeted for determination is different from the payload value of the data received directly therebefore and determined to be normal, that is whether the payload value has changed.

When the event data targeted for determination is received directly after the reception time of first cyclic data (reference data) serving as a reference, the processing unit 20 of the onboard device 2 determines whether the payload value, that is, each signal value, has changed (is different) between the event data and the first cyclic data. When the event data targeted for determination is received directly after the reception time of event data that has already been determined to be normal, the processing unit 20 of the onboard device 2 determines whether the payload value (each signal value) has changed (is different) between the event data targeted for determination and the event data that has already been determined to be normal. As described above, the processing unit 20 of the onboard device 2 performs determination processing sequentially on event data stored in time series according to the reception times in the data reception list, and is thus able to efficiently specify data (cyclic data or event data received directly before and determined to be normal) to be compared with the event data targeted for determination.

If the payload value has not changed (is not different) (S106: NO), the processing unit 20 of the onboard device 2 determines that the event data targeted for determination is anomalous (anomaly detected (range)) (S1061). Event data has the transmission characteristic of being transmitted in an event-driven manner, when a phenomenon (event) occurs such as a change in the payload value. Accordingly, when the payload value has not changed (is not different), that is, when the payload value of the event data is the same as the payload value of the data for comparison (cyclic data or event data received directly before and determined to be normal), the processing unit 20 of the onboard device 2 determines that the event data is anomalous (anomaly detected (range)).

If the payload value has changed (is different) (S106: YES), the processing unit 20 of the onboard device 2 determines that the event data targeted for determination is normal (S107). When the payload value has changed (is different), that is, when the payload value of the event data is different from the payload value of the data for comparison (cyclic data or event data received directly before and determined to be normal), the processing unit 20 of the onboard device 2 provisionally determines that the event data is normal. The processing unit 20 of the onboard device 2 adds the determination result for the event data that is the determination target to the forecast result field in the data reception list.

The processing unit 20 of the onboard device 2 determines whether determination on all of the received event data has ended (S108). The processing unit 20 of the onboard device 2 determines whether determination on all of the event data has ended, that is, whether there is event data on which determination processing (forecast processing) has not been implemented, by referring to the data reception list stored in the storage unit 21.

If determination on all of the event data has not ended (S108: NO), the processing unit 20 of the onboard device 2 performs loop processing in order to execute the processing of S103 again. At this time, the processing unit 20 of the onboard device 2 executes the processing from S103 with the event data received directly after the event data on which determination processing was currently performed as the determination target, with reference to the data reception list. Determination processing (forecast processing) can thereby be performed sequentially on a plurality of received event data from the event data with the oldest reception time.

If determination on all of the event data has ended (S108: YES), the processing unit 20 of the onboard device 2 executes backcast processing, by first starting processing for determining whether the payload values of the event data received last is the same as the cyclic data received second (S109). Rather than executing backcast processing on all of the received event data, the processing unit 20 of the onboard device 2 may be configured to execute backcast processing only on event data whose reception time is determined to not be within the event transmission prohibition period (S103: NO) and to be within the normal value range (S105: YES).

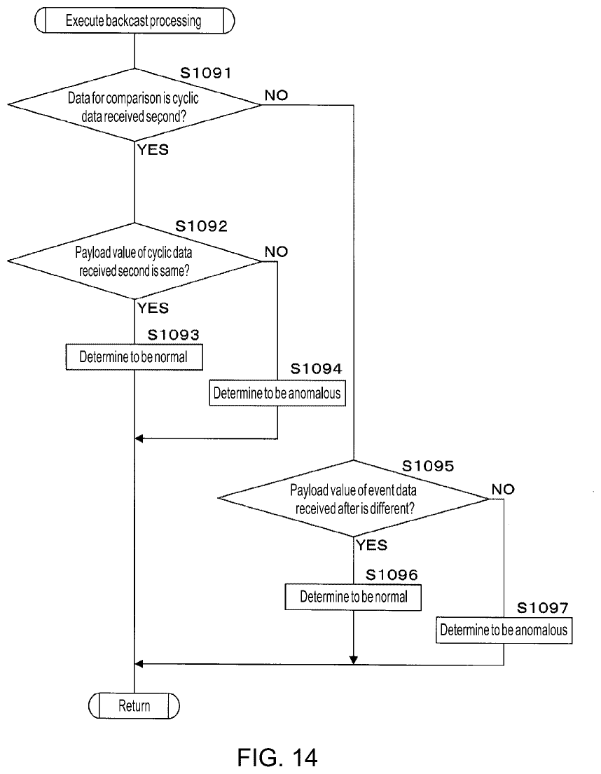

FIG. 14 is a flowchart (backcast processing) illustrating processing by the processing unit 20 of the onboard device 2. The processing unit 20 of the onboard device 2 executes backcast processing (S109) sequentially on a plurality of received event data, based on this flowchart. That is, the processing unit 20 of the onboard device 2, through comparison with the payload value of cyclic data received second or the payload value of event data determined to be normal, retrospectively performs validity determination sequentially on event data received before the cyclic data or event data for comparison.

The processing unit 20 of the onboard device 2 determines whether the data for comparison is the cyclic data received second (S1091). The processing unit 20 of the onboard device 2 determines whether the data for comparison of the payload value is the cyclic data received second, that is, whether the event data targeted for determination is event data received closest to the reception time of the cyclic data received second. The basis for comparing the payload values (signal values) differs depending on whether the data for comparison is the cyclic data received second or event data determined to be normal. Accordingly, the processing unit 20 of the onboard device 2 determines whether the data for comparison for determining the validity of the event data is the cyclic data received second, based on the respective reception times of the plurality of event data, with reference to the data reception list stored in the storage unit 21.

If the data for comparison is the cyclic data received second (S1091: YES), the processing unit 20 of the onboard device 2 determines whether the payload values of the event data targeted for determination and the cyclic data received second are the same (S1092). When the data for comparison is the cyclic data received second, the processing unit 20 of the onboard device 2 determines whether the payload values (all signal values) of the event data targeted for determination and the cyclic data received second are the same. In the determination of the sameness of the payload values (all signal values), the processing unit 20 of the onboard device 2 may be configured to determine that the payload values are the same (substantively the same), when the difference (deviation or absolute value of differences, etc.) between the payload values (signal values) is less than or equal to a predetermined value. The processing unit 20 of the onboard device 2 is able to determine the substantive sameness of the value of the payload of event data and the value of the payload of data received thereafter, by setting the predetermined value (threshold value for difference determination) that is used when determining the difference in payload value at 0 or a comparatively small value close to 0.

If the payload values of the event data targeted for determination and the cyclic data received second are the same (S1092: YES), the processing unit 20 of the onboard device 2 determines that the event data targeted for determination is normal (S1093). When the payload values are the same, that is, when the payload values (all signal values) of the event data received last (event data targeted for determination) and the cyclic data received second are the same, the processing unit 20 of the onboard device 2 determines that the event data targeted for determination is normal.

If the payload values of the event data targeted for determination and the cyclic data received second are not the same (S1092: NO), the processing unit 20 of the onboard device 2 determines that the event data targeted for determination is anomalous (S1094). When the payload values of the event data targeted for determination and the cyclic data received second are not the same, that is, are different, the processing unit 20 of the onboard device 2 determines that the event data targeted for determination is anomalous. In this case, the processing unit 20 of the onboard device 2 determines that the event data targeted for determination is anomalous (anomaly detected (range)).

If the data for comparison is not the cyclic data received second (S1091: NO), the processing unit 20 of the onboard device 2 determines whether the payload values of the event data targeted for determination is different from the event data received thereafter (S1095). When the data for comparison is not the cyclic data received second, that is, when the data for comparison is event data determined to be normal and received directly after the reception time of the event data targeted for determination, the processing unit 20 of the onboard device 2 determines whether the payload values (any of the signal values) of the event data targeted for determination and the event data received thereafter are different. In the determination of the sameness of the payload values (all signal values), the processing unit 20 of the onboard device 2 may be configured to determine that the payload values are different (are not substantively the same) when the difference (deviation or absolute value of differences, etc.) between the payload values (signal values) is greater than a predetermined value.

If the payload values of the event data targeted for determination and the event data received thereafter are different (S1095: YES), the processing unit 20 of the onboard device 2 determines that the event data targeted for determination is normal (S1096). When the payload values are different, that is, when the payload values (any of the signal values) of the event data targeted for determination and the event data received thereafter are different, the processing unit 20 of the onboard device 2 determines that the event data targeted for determination is normal.

If the payload values of the event data targeted for determination and the event data received thereafter are not different (S1095: NO), the processing unit 20 of the onboard device 2 determines that the event data targeted for determination is anomalous (S1097). When the payload values of the event data targeted for determination and the event data received thereafter are not different, that is, are the same, the processing unit 20 of the onboard device 2 determines that the event data targeted for determination is anomalous. In this case, the processing unit 20 of the onboard device 2 determines that the event data targeted for determination is anomalous (anomaly detected (range)). The processing unit 20 of the onboard device 2 stores the determination result (normal or anomalous) of the backcast processing for each of the event data that has undergone the respective processing described above in the storage unit 21, by adding the determination result to the backcast result field in the data reception list.

After executing the processing of S109 (S1091 to S1097), the processing unit 20 of the onboard device 2 determines whether determination on all of the event data has ended (S110). The determination result (normal or anomalous) of the backcast processing for each of the event data is added to the data reception list, and the processing unit 20 of the onboard device 2 is able to grasp the progress of the backcast processing on each of the event data, by referring to the data reception list.

The processing unit 20 of the onboard device 2 continuously performs, with respect to a plurality of event data, backcast processing sequentially on all of the event data retrospectively from the event data received last. Alternatively, the processing unit 20 of the onboard device 2 may be configured to retrospectively perform, with respect to a plurality of event data, backcast processing on the event data sequentially from the event data received last, and, if any of the event data is determined to be anomalous, to suspend the backcast processing. The processing unit 20 of the onboard device 2 may, for example, be configured to specify the data class of the event data targeted for determination, with reference to the data class table, and, if any of the event data is determined to be anomalous, to determine whether to continue the backcast processing on all of the event data or to suspend the backcast processing, based on the backcast flag defined for the specified data class.

Accordingly, the case where determination on all of the event data has ended (end condition of backcast processing is satisfied) differs according to the setting of the backcast flag in the data class table, and includes the case where processing of all of the received event data has ended (backcast flag: 1) and the case where any of the event data is determined to be anomalous (backcast flag: 0). Favorable determination processing that depends on the data class of the event data targeted for determination can be performed, by selectively continuing or suspending the backcast processing according to the data class. When determination on all of the event data has not ended (end condition of backcast processing is not satisfied) (S110: NO), the processing unit 20 of the onboard device 2 performs loop processing in order to execute the processing of S109 (S1091 to S1097) again.

If determination on all of the event data has ended (S110: YES), the processing unit 20 of the onboard device 2 derives the final determination result, for each of the event data targeted for determination, according to the forecast result and the backcast result (S111). The processing unit 20 of the onboard device 2 derives the final determination result, for each of the event data targeted for determination, according to the forecast result and the backcast result in the data reception list. For event data having only a forecast result, among the event data targeted for determination, the processing unit 20 of the onboard device 2 derives the forecast result as the final determination result.

For event data having a forecast result and a backcast result, among the event data targeted for determination, the processing unit 20 of the onboard device 2 derives the final determination result, based on the combination of the forecast result and the backcast result. The processing unit 20 of the onboard device 2 may, for example, be configured to derive the final determination result, based on the combination of the forecast result and the backcast result, with reference to the determination table stored in the storage unit 21.

When the forecast result and the backcast result are both normal (OK), the processing unit 20 of the onboard device 2 may be configured to derive, as the final determination result, information to the effect that the event data is normal. When the forecast result and the backcast result are both anomalous (NG), the processing unit 20 of the onboard device 2 may be configured to derive, as the final determination result, information to the effect that the event data is anomalous (anomaly detected (specific)). When the forecast result and the backcast result are different, the processing unit 20 of the onboard device 2 may be configured to derive, as the final determination result, information to the effect that the event data is anomalous (anomaly detected (range)).

The processing unit 20 of the onboard device 2 may be configured to store the derived final determination results in the storage unit 21 as log information, by storing (adding) the derived final determination results in the data reception list. The processing unit 20 of the onboard device 2 may be configured to output the data reception list stored as log information to the external server 100 or the display device 5.

In the present embodiment, the processing unit 20 of the onboard device 2 may be configured to perform parallel computation (parallel processing) of backcast processing such as S109 and forecast processing such as S106, using multi-core or multi-CPU hardware resources. By parallelizing a plurality of types of processing on event data in this way, the processing time (elapsed time) required for validity determination processing of event data can be reduced.

### Second Embodiment

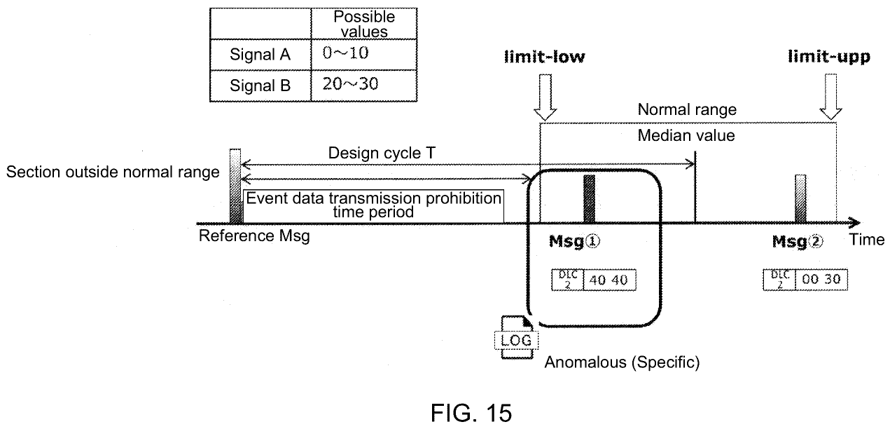

FIG. 15 is an illustrative diagram relating to validity determination (payload value) of a plurality of cyclic data according to a second embodiment (multiple reception in normal cycle range). In the illustrative example of the present embodiment, the first cyclic data (reference Msg) is determined to be normal, and the event data transmission prohibition period and the normal value range are determined on the basis of the reception time of the first cyclic data (reference Msg). In the normal cycle range, a plurality of cyclic data (Msg1, Msg2) are received. The processing unit 20 of the onboard device 2 determines whether the payload value (signal values) of each of the received cyclic data (Msg1) and cyclic data (Msg2) is included in the normal value range (possible values).

In the illustrative example of the present embodiment, the payload area of the cyclic data (Msg1, Msg2) includes the values of signal A and signal B. Even if only one of the plurality of signal values is outside the normal value range, the processing unit 20 of the onboard device 2 may be configured to determine that the event data including the signal value outside the normal value range (signal value outside possible range) in the payload area is anomaly detected (specific) “anomalous (specific)”. The payload value (signal values) of the cyclic data (Msg1) is outside the payload normal value range (normal value ranges of signals A and B) defined in the data class table. Accordingly, the processing unit 20 of the onboard device 2 determines that the cyclic data (Msg1) is anomaly detected (specific) “anomalous (specific)”. The payload value (signal values) of the cyclic data (Msg2) is within the payload normal value range (normal value ranges of signals A and B) defined in the data class table. Accordingly, the processing unit 20 of the onboard device 2 determines that the cyclic data (Msg2) is normal.

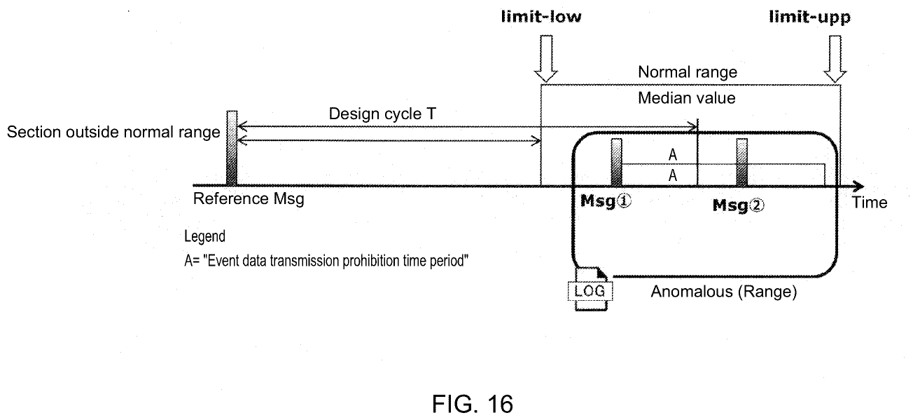

FIG. 16 is an illustrative diagram relating to validity determination of a plurality of cyclic data (event data transmission prohibition period). In the illustrative example of the present embodiment, the cyclic data (reference Msg) received first is determined to be normal, and the event data transmission prohibition period and the normal value range are determined on the basis of the reception time of the cyclic data (reference Msg) received first. In the normal cycle range, a plurality of cyclic data (Msg1, Msg2) are received. The payload value (signal values) of each of cyclic data (Msg1) and cyclic data (Msg2) is within the payload normal value range, and, in terms of the payload value (signal values), the plurality of cyclic data (Msg1, Msg2) are determined to be normal.

The processing unit 20 of the onboard device 2 determines whether the interval of the reception times of the two pieces of cyclic data (Msg1, Msg2) determined to be normal in terms of the payload value (signal values) and having consecutive reception times is less than or equal to the event data transmission prohibition time period defined in the data class table. That is, it is determined, out of the two pieces of cyclic data (Msg1, Msg2) determined to be normal in terms of the payload value (signal values) and having consecutive reception times, whether the reception time of the later cyclic data (Msg2) is included in the event data transmission prohibition period set on the basis of the reception time of the earlier cyclic data (Msg1). When the reception time is not included in the event data transmission prohibition period, that is, when the interval of the reception times is longer than the event data transmission prohibition time period, the processing unit 20 of the onboard device 2 determines that the two pieces of cyclic data (Msg1, Msg2) having consecutive reception times are normal. When the reception time is included in the event data transmission prohibition period, that is, when the interval of the reception times is less than or equal to the event data transmission prohibition time period, the processing unit 20 of the onboard device 2 determines that the two pieces of cyclic data (Msg1, Msg2) having consecutive reception times are both anomaly detected (range) “anomalous (range)”. When a plurality of cyclic data are received within the same normal cycle range, the processing unit 20 of the onboard device 2 may be configured transition to a reference data reception state (reference message acquisition state) in which data (cyclic data) that serves as a reference in specifying the next normal cycle range is received, as described in International Patent Publication No. WO 2022/185566(WO/2022/185566 ), for example.

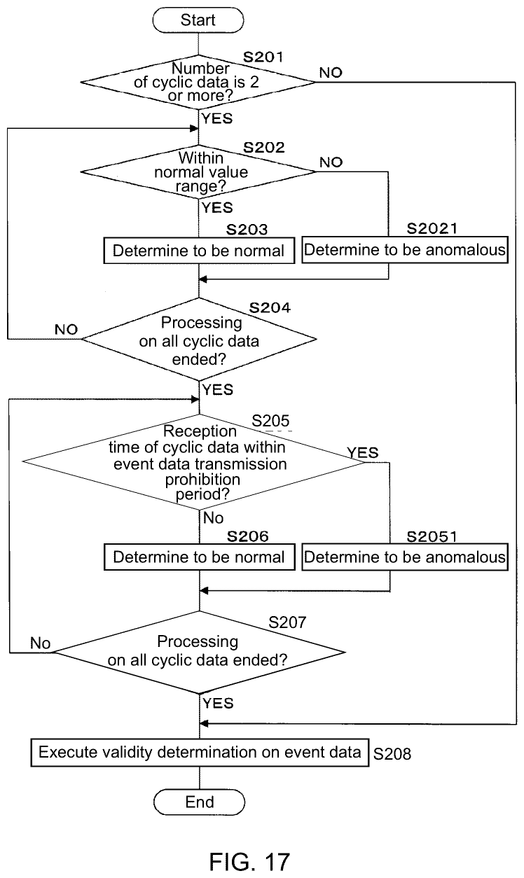

FIG. 17 is a flowchart illustrating processing by the processing unit 20 of the onboard device 2. The processing unit 20 of the onboard device 2 regularly performs the following processing in a state where, for example, the vehicle C has started up (IG switch 6 or power switch is on) or stopped (IG switch 6 or power switch is off). In this processing, even if the number of cyclic data received in the normal cycle range is two or more, the processing unit 20 of the onboard device 2 performs validity determination in terms of the payload value and event data transmission prohibition time period, rather than uniformly determining that the two or more pieces of cyclic data are anomalous (anomaly detected (range)). Accordingly, the processing in the present embodiment corresponds to processing that further extends the processing of S104 and S1041 described in the first embodiment.

The flowchart of the present embodiment will be described with the processing unit 20 of the onboard device 2 in the case where the number of cyclic data received within the normal cycle range is two or more. Note that with regard to the various processing on event data received outside the normal cycle range, the processing unit 20 of the onboard device 2 may be configured to perform similar processing to the first embodiment. The processing unit 20 of the onboard device 2 determines whether the number of cyclic data received in the normal cycle range is two or more (S201). The processing unit 20 of the onboard device 2 determines whether the number of cyclic data received within the normal cycle range set in the processing of S101 of the first embodiment is two or more, for example. Even if the processing unit 20 of the onboard device 2 was configured to perform processing with data received within the normal cycle range regarded as cyclic data, it is envisaged that, by setting the upper and lower limit values of the normal cycle range to comparatively large values, two pieces of data will be received consecutively within the same normal cycle range, and it is possible that one of the two pieces of data is event data. Even in such cases, the processing unit 20 of the onboard device 2 performs validity determination in terms of the payload value and data transmission characteristics on the two pieces of data (cyclic data and substantively event data) received consecutively within the same normal value range, since received data and the reception times thereof are stored in the storage unit 21 (saved to data reception list) in association with each other.

If the number of cyclic data received within the normal cycle range is two or more (S201: YES), the processing unit 20 of the onboard device 2 determines whether the payload value of the cyclic data targeted for determination is within the normal value range (S202). When two or more pieces of cyclic data are received within the normal cycle range, the processing unit 20 of the onboard device 2 determines whether the payload value of each of the cyclic data is within the normal value range. The processing unit 20 of the onboard device 2 determines whether the payload value of the cyclic data targeted for determination falls within the payload normal value range determined by the data class of the cyclic data, by referring to the data class table stored in the storage unit 21, for example. The processing unit 20 of the onboard device 2 may be configured to start the determination processing sequentially from the cyclic data with the oldest reception time. The processing unit 20 of the onboard device 2 determines whether each of the signal values included in the payload area is within the normal value range, similarly to the determination processing on event data in S105 of the first embodiment.

If not within the normal value range (S202: NO), the processing unit 20 of the onboard device 2 determines that the cyclic data targeted for determination is anomalous (S2021). When the payload value (any of the signal values) of the cyclic data targeted for determination is not within the normal value range, the processing unit 20 of the onboard device 2 determines that the cyclic data targeted for determination corresponds to specific anomaly detected “anomaly detected (specific)”.

If within the normal value range (S202: YES), the processing unit 20 of the onboard device 2 determines that the cyclic data targeted for determination is normal in terms of the payload value (S203). When it is determined that the payload value (all signal values) of the cyclic data targeted for determination is within the normal value range, the processing unit 20 of the onboard device 2 may be configured to provisionally determine that the cyclic data targeted for determination is normal in terms of the payload value (signal values), and to store information to the effect that the cyclic data was determined to be normal in the storage unit 21. Cyclic data determined to be normal in terms of the payload value (signal values) in this way serves as cyclic data with which validity determination in terms of the event data transmission prohibition period is implemented.

The processing unit 20 of the onboard device 2 determines whether processing on all of the received cyclic data has ended (S204). If processing on all of the cyclic data has not ended (S204: NO), the processing unit 20 of the onboard device 2 performs loop processing in order to execute the processing of S202 again. The processing unit 20 of the onboard device 2 determines whether determination on all of the cyclic data received within the same normal cycle range has ended, that is, whether there is cyclic data on which determination processing in terms of the payload value (signal values) has not been implemented, by referring to the data reception list stored in the storage unit 21.

If processing on all of the cyclic data has ended (S204: YES), the processing unit 20 of the onboard device 2 determines whether the reception time of the cyclic data is within the event data transmission prohibition period (S205). The processing unit 20 of the onboard device 2 determines whether the reception time of the cyclic data targeted for determination is included within the event data transmission prohibition period set on the basis of the reception time of cyclic data received closest to the reception time of the cyclic data targeted for determination, targeting only the cyclic data whose payload value was determined, as the processing result of S202, to be within the normal value range.

The processing unit 20 of the onboard device 2 determines whether the reception time of the cyclic data received second is included within the event data transmission prohibition period set on the basis of the reception time of the cyclic data received first, out of two pieces of cyclic data whose payload values are determined to be within the normal value range in this way and having consecutive reception times. That is, the processing unit 20 of the onboard device 2 determines whether the interval between the reception time of the cyclic data targeted for determination (cyclic data received second) and the reception time of the cyclic data received closest thereto (cyclic data received first) is less than or equal to the event data transmission prohibition time period defined in the data class table. In this case, the reception time of the cyclic data initially received, out of the plurality of cyclic data received within the same normal cycle range, is the start time of the event data transmission prohibition period. Accordingly, the cyclic data initially received is excluded from the determination processing as to whether the reception time is within the event data transmission prohibition period. The cyclic data serving as the basis of the event data transmission prohibition period (cyclic data received closest to the reception time of the cyclic data targeted for determination) is also cyclic data whose payload value is determined to be within the normal value range.

If the reception time of the cyclic data is within the event data transmission prohibition period (S205: YES), the processing unit 20 of the onboard device 2 determines that the cyclic data is anomalous (S2051). When the reception time of the cyclic data is within the event data transmission prohibition period, that is, when the interval between the reception time of the cyclic data targeted for determination and the reception time of the cyclic data received closest thereto is less than or equal to the event data transmission prohibition time period defined in the data class table, the processing unit 20 of the onboard device 2 determines that the cyclic data targeted for determination is anomalous. In this case, the processing unit 20 of the onboard device 2 may be configured to determine that not only the cyclic data targeted for determination but also the cyclic data serving as the basis for the event data transmission prohibition period is anomalous, and determine that these two pieces of cyclic data are anomaly detected (range) “anomalous (range)”.

If the reception time of the cyclic data is not within the event data transmission prohibition period (S205: NO), the processing unit 20 of the onboard device 2 determines that the cyclic data is normal (S206). When the reception time of the cyclic data is not within the event data transmission prohibition period, that is, when the interval between the reception time of the cyclic data targeted for determination and the reception time of the cyclic data received closest thereto is longer than the event data transmission prohibition time period defined in the data class table, the processing unit 20 of the onboard device 2 determines that the cyclic data targeted for determination is normal.

The processing unit 20 of the onboard device 2 determines whether processing on all of the received cyclic data has ended (S207). If processing on all of the cyclic data has not ended (S207: NO), the processing unit 20 of the onboard device 2 performs loop processing in order to execute the processing of S205 again. Even when three or more pieces of cyclic data are received within the same normal cycle range, determination processing can thereby be performed sequentially on the received cyclic data.

If processing on all of the cyclic data has ended (S207: YES), or when the number of received cyclic data is not two or more (S201: NO), the processing unit 20 of the onboard device 2 executes validity determination of event data (S208). The processing unit 20 of the onboard device 2 executes validity determination of event data similarly to the first embodiment, after receiving two or more pieces of cyclic data and executing validity determination on the received cyclic data. The validity determination of event data may include the processing from S102 to S111 described in the first embodiment. When the number of cyclic data received in the normal cycle range is two or more, the processing unit 20 of the onboard device 2 may be configured to transition to the reference data reception state (reference message acquisition state) in which data (cyclic data) that serves as a reference in specifying the next normal cycle range is received, as described in International Patent Publication No. WO 2022/185566(WO/2022/185566 ), for example.

When the number of cyclic data received in the normal cycle range is not two or more, that is, when the number of received cyclic data is one, the processing unit 20 of the onboard device 2 performs validity determination of event data similarly to the first embodiment. Alternatively, when no cyclic data is received in the normal cycle range, the processing unit 20 of the onboard device 2 may be configured to determine that received event data is anomalous (anomaly detected (range)), similarly to S1041 in the first embodiment. When no cyclic data is received in the normal cycle range, the processing unit 20 of the onboard device 2 may be configured to transition to the reference data reception state (reference message acquisition state) in which data (cyclic data) that serves as a reference in specifying the next normal cycle range is received, as described in International Patent Publication No. WO 2022/185566(WO/2022/185566 ), for example.

The embodiments disclosed herein are to be considered in all respects as illustrative and not restrictive. The scope of the disclosure is defined not by the foregoing purport but by the patent claims, and all changes that come within the meaning and range of equivalency of the patent claims are intended to be embraced therein.

Any two or more of the individual claims set forth in the patent claims may be combined with each other, regardless of citation. In the patent claims, multiple dependent claims depending from more than one claim may be set forth. Multiple dependent claims depending from another multiple dependent claim may also be set forth. Even if multiple dependent claims depending from another multiple dependent claim are not set forth, this does not restrict multiple dependent claims depending from another multiple dependent claim from being set forth.

1. An onboard device to be connected to an in-vehicle network installed in a vehicle, comprising:
a processing unit configured to perform processing relating to validity determination of data flowing through the in-vehicle network,
wherein the processing unit
receives cyclic data transmitted cyclically over the in-vehicle network,
determines, in a case where a plurality of event data of a same class as the cyclic data are received between reception times of two pieces of consecutively received cyclic data, whether an interval of the reception times of two pieces of consecutively received event data is longer than an event data transmission prohibition period determined as a period in which transmission of the event data is prohibited,
determines, in a case where the interval of the reception times of the two pieces of consecutively received event data is not longer than the event data transmission prohibition period, that at least one of the two pieces of consecutively received event data is anomalous, and
performs, in a case where the interval of the reception times of the two pieces of consecutively received event data is longer than the event data transmission prohibition period, validity determination relating to a value of a payload of the event data.

2. The onboard device according to claim 1, wherein the event data transmission prohibition period set for each of the plurality of event data of the same class received between the reception times of two pieces of consecutively received cyclic data is a same period.

3. The onboard device according to claim 1,
wherein the processing unit
sets a normal cycle range on a basis of the reception time of the cyclic data received first, out of the two pieces of consecutively received cyclic data, and
in a case where the event data transmission prohibition period set on a basis of the reception time of any of the plurality of received event data overlaps with the normal cycle range, shortens the event data transmission prohibition period such that an end time of the event data transmission prohibition period is before a start time of the normal cycle range.

4. The onboard device according to claim 1,
wherein the processing unit
in a case where a difference between a value of a payload of the cyclic data received second, out of the two pieces of consecutively received cyclic data, and a value of a payload of the event data received directly before the cyclic data received second is less than or equal to a predetermined value, determines that the event data received directly before is normal, and
based on the value of the payload of the event data determined to be normal and a value of a payload of other event data received before the event data determined to be normal, performs validity determination of the other event data.

5. The onboard device according to claim 4,
wherein the processing unit
performs validity determination on the plurality of event data, based on a change in the value of the payload between the plurality of event data, and
in a case where there is no change in the value of the payload between two pieces of consecutively received event data, determines that at least one of the two pieces of consecutively received event data is anomalous.

6. The onboard device according to claim 5, wherein the processing unit, in a case where it is determined that at least one of the two pieces of consecutively received event data is anomalous, suspends determination processing that is based on comparison with the value of the payload of the event data determined to be normal or the cyclic data received second, with respect to other event data received before the event data determined to be anomalous.

7. The onboard device according to claim 5, wherein the processing unit, in a case where it is determined that at least one of the two pieces of consecutively received event data is anomalous, continues determination processing that is based on comparison with the value of the payload of the event data determined to be normal or the cyclic data received second, with respect to other event data received before the event data determined to be anomalous.

8. The onboard device according to claim 1,
wherein the processing unit
in a case where a plurality of cyclic data are received in a normal cycle range set on a basis of the reception time of the cyclic data received first and whose upper limit value and lower limit value are set with a transmission cycle determined based on the class of the cyclic data as a reference value, determines whether the value of the payload of each of the plurality of cyclic data is within a normal value range determined in advance according to the class of the cyclic data, and
in a case where it is determined that the value of the payload of the cyclic data is not within the normal value range, determines that the cyclic data is anomalous.

9. The onboard device according to claim 8,
wherein the processing unit
in a case where it is determined that the values of the payloads of the cyclic data are within the normal value range, determines whether the interval of the reception times of two pieces of consecutively received cyclic data, out of the plurality of cyclic data received in the normal cycle range, is longer than the event data transmission prohibition period,
in a case where the interval of the reception times of the two pieces of consecutively received cyclic data is not longer than the event data transmission prohibition period, determines that at least one of the two pieces of consecutively received cyclic data is anomalous, and
in a case where the interval of the reception times of the two pieces of consecutively received cyclic data is longer than the event data transmission prohibition period, determines that the two pieces of consecutively received cyclic data are normal.

10. A program for causing a computer connected to an in-vehicle network to execute processing for:
receiving cyclic data transmitted cyclically over the in-vehicle network;
determining, in a case where a plurality of event data of a same class as the cyclic data are received between reception times of two pieces of consecutively received cyclic data, whether an interval of the reception times of two pieces of consecutively received event data is longer than an event data transmission prohibition period determined as a period in which transmission of the event data is prohibited;
determining, in a case where the interval of the reception times of the two pieces of consecutively received event data is not longer than the event data transmission prohibition period, that at least one of the two pieces of consecutively received event data is anomalous; and
performing, in a case where the interval of the reception times of the two pieces of consecutively received event data is longer than the event data transmission prohibition period, validity determination relating to a value of a payload of the event data.

11. An information processing method for causing a computer connected to an in-vehicle network to execute processing for:
receiving cyclic data transmitted cyclically over the in-vehicle network;
determining, in a case where a plurality of event data of a same class as the cyclic data are received between reception times of two pieces of consecutively received cyclic data, whether an interval of the reception times of two pieces of consecutively received event data is longer than an event data transmission prohibition period determined as a period in which transmission of the event data is prohibited;
determining, in a case where the interval of the reception times of the two pieces of consecutively received event data is not longer than the event data transmission prohibition period, that at least one of the two pieces of consecutively received event data is anomalous; and
performing, in a case where the interval of the reception times of the two pieces of consecutively received event data is longer than the event data transmission prohibition period, validity determination relating to a value of a payload of the event data.
